(19) United States
(12) Patent Application Publication
(10) Pub. No.: US 2012/0227604 A1
(43) Pub. Date: Sep. 13, 2012

(54) THERMAL POSITIVE-TYPE PLANOGRAPHIC ORIGINAL PRINTING PLATE AND METHOD OF MAKING PLANOGRAPHIC PRINTING PLATE

(75) Inventors: Yoshinori TAGUCHI, Haibara-gun (JP); Hidekazu OOHASHI, Haibara-gun (JP)

(73) Assignee: FUJIFILM CORPORATION, Tokyo (JP)

(21) Appl. No.: 13/408,037

(22) Filed: Feb. 29, 2012

(30) Foreign Application Priority Data
Mar. 11, 2011 (JP) 2011-053869

(51) Int. Cl. B41N 1/04; B41N 3/03

(52) U.S. Cl. 101/453; 101/463.1

(57) ABSTRACT

A thermal positive-type planographic original printing plate comprising a support and at least one recording layer provided on the support, either the same layer or different layers of the recording layer comprising: a star polymer in which at least 3 polymer chains bind to a core comprised atomic groups and are radially branching; and an infrared absorbing agent.

### FIELD OF THE INVENTION

The present invention relates to a thermal positive-type planographic original printing plate and method of making planographic printing plate.

### BACKGROUND OF THE INVENTION

The progress of laser exposure and development related technology in planographic printing has been astonishing. Especially for the solid laser and the semiconductor laser each of which has an emitting region in the range of from near-infrared to infrared, a high power and compact one is easily available. The laser is extremely useful as an exposure source at the time when a plate is made directly using digital data from a computer and the like. Accordingly, development of a planographic original printing plate that copes with this type of the plate making is extremely important.

The recording layer of a positive-type planographic original printing plate for infrared laser contains, as essential components, an alkali-soluble binder resin and an IR dye or the like that absorbs light to generate heat. This IR dye or the like in the unexposed area (image area) acts as a development inhibitor that substantially reduces solubility with respect to a developing solution for the binder resin due to interaction with the binder resin. Meanwhile, in the exposed area (non-image area), an interaction between the IR dye or the like and the binder resin is weakened due to the generated heat, and the binder resin is dissolved with an alkali developing solution to form a planographic printing plate. However, this positive-type planographic printing plate material for infrared laser is not satisfactory in terms of processability (development latitude) with the fatigued developing solution having become less active.

A means that can be thought in order to improve the development latitude-related performance is to use a recording layer the non-exposed area of which can be more easily developed, that is, a recording layer composed of a material having better solubility with respect to an alkali aqueous solution. However, this recording layer is chemically weakened also in the exposed area, and resultantly tends to be not only less durable in a standard printing, but also less chemically resistant such that the recording layer becomes susceptible to damage caused by an ink cleaning solvent, a plate cleaner, or the like.

The following technique has been developed on ahead by the present inventors in order to improve the development latitude, or the like. That is, the present inventors have proposed the technique in which the recording layer is multilayered so that a lower layer having high-alkali solubility is disposed and a particular polymer compound is applied to an upper layer above the lower layer (see, for example, JP-A-11-218914; “JP-A” means an unexamined publication of Japanese Patent Application).

### SUMMARY OF THE INVENTION

The present invention resides in a thermal positive-type planographic original printing plate comprising a support and at least one recording layer provided on the support, either the same layer or different layers of the recording layer comprising: a star polymer in which at least 3 polymer chains bind to a core comprised atomic groups and are radially branching; and an infrared absorbing agent.

Other and further features and advantages of the invention will appear more fully from the following description, appropriately referring to the accompanying drawing.

### BRIEF DESCRIPTION OF THE DRAWING

FIG. 1 is a sectional view schematically showing an embodiment in which the planographic original printing plate of the present invention has a multilayer configuration.

FIG. 2 is a sectional view schematically showing an embodiment in which the planographic original rinting plate of the present invention has a single layer configuration.

### DETAILED DESCRIPTION OF THE INVENTION

In view of the technique disclosed in the above-described patent literature, the present inventors have aimed for further improvement in printing performance of the planographic printing plate, and have investigated materials that enable to satisfy a recent demand performance and also to realize good development latitude.

A first purpose of the present invention is to provide a thermal positive-type planographic original rinting plate that satisfies a high level of characteristics demanded for the planographic printing plate, such as chemical resistance including retention of the unexposed area against a processing, a good developability of the exposed area, and a good durability (plate durability), and that realizes a high development latitude, and further to provide a method of producing the thermal positive-type planographic original printing plate. A second purpose of the present invention is to provide a thermal positive-type planographic original printing plate that exhibits high performances in the above-described terms and shows less reduction in developability due to aging after exposure (namely, a good stability after printing), even in the case where a low p H developing solution is employed, and also to provide a method of producing the thermal positive-type planographic original printing plate.

According to the present invention, there are provided the following means:

(1) A thermal positive-type planographic original printing plate comprising a support and at least one recording layer provided on the support, either the same layer or different layers of the recording layer comprising: a star polymer in which at least 3 polymer chains bind to a core comprised atomic groups and are radially branching; and an infrared absorbing agent.

(2) The thermal positive-type planographic original printing plate described in the item (1), wherein the star polymer is at least one of compounds represented by formulae (I) to (VIII):

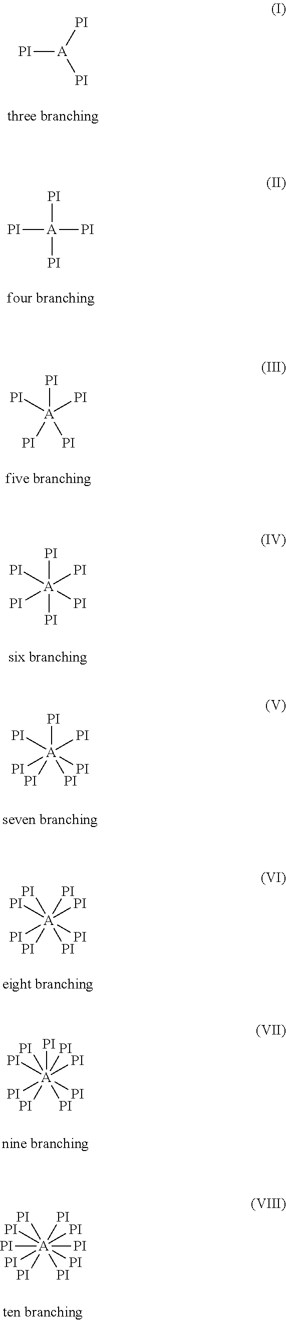

wherein P1 represents a polymer chain having a molecular weight of 1,000 to 1,000,000; and A represents a group of atoms having a molecular weight of 100 to 1,500.

(3) The thermal positive-type planographic original printing plate described in the item (2), wherein A in the above-described formulae (I) to (VIII) is a compound derived from a sulfur-containing chain transfer agent.

(4) The thermal positive-type planographic original printing plate described in any one of the items (1) to (3), wherein a raw material compound that forms the core of the above-described star polymer is represented by any one of the following formula (CT-1) to Formula (CT-9):

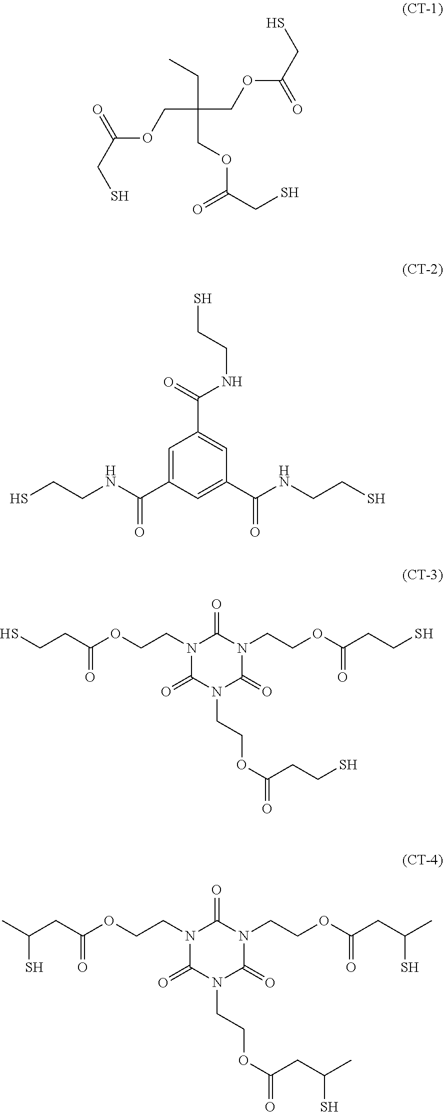

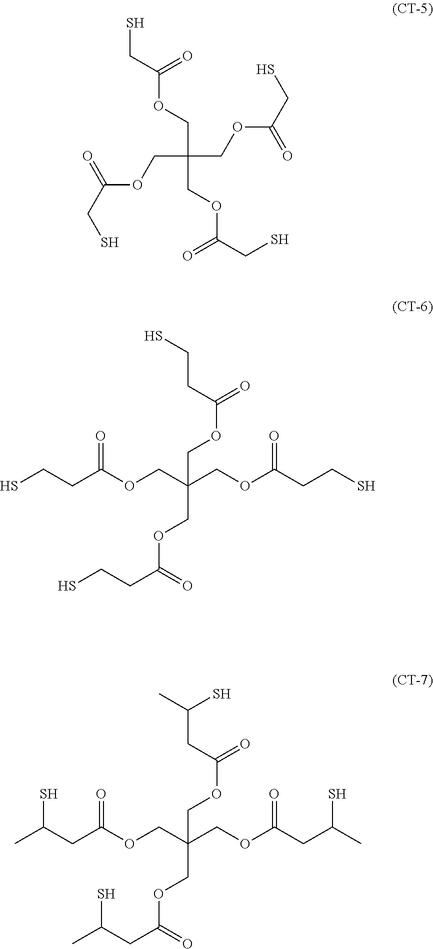

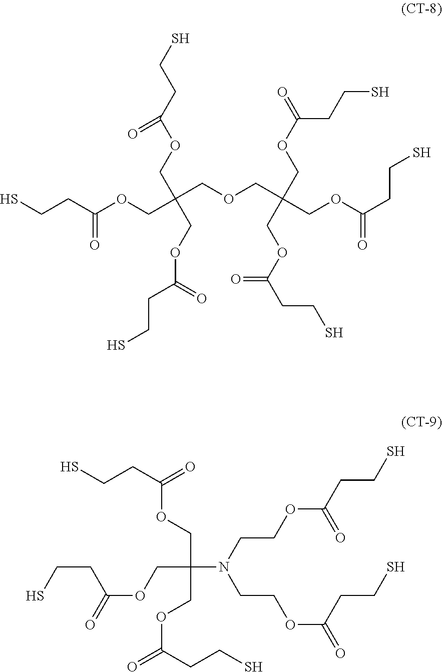

(5) The thermal positive-type planographic original printing plate described in any one of the items (2) to (4), wherein the polymer side chain P1 of the above-described formulae (I) to (VIII) is derived from the compound selected from the group consisting of the compounds represented by the following formulae (A) to (C):

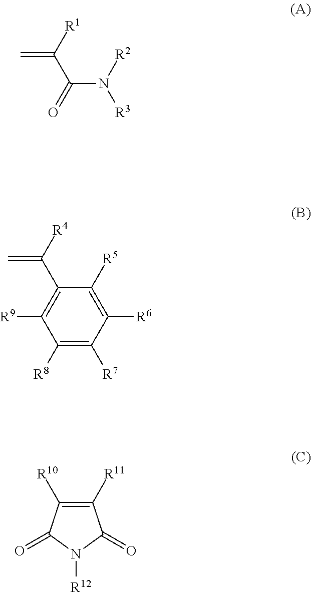

wherein R¹ and R⁴ represent a hydrogen atom or a methyl group; R², R³, R⁵ to R¹² each independently represents a hydrogen atom or a monovalent organic group; and R² and R³, and R¹⁰ and R¹¹ may bind to each other to form a ring.

(6) The thermal positive-type planographic original printing plate described in any one of the items (1) to (5), wherein the above-described recording layer further comprises an alkali-soluble resin.

(7) The thermal positive-type planographic original printing plate described in any one of the items (1) to (6), wherein the thermal positive-type planographic original printing plate comprises, in the following order as layers on the above-described support, an undercoat layer, and a lower layer and an upper layer each of which serves as the recording layer.

(8) The thermal positive-type planographic original printing plate described in the item (7), wherein the upper layer or the lower layer of the recording layer comprises the above-described star polymer, and the upper layer further comprises a novolac resin that serves as the above-described alkali-soluble resin.

(9) The thermal positive-type planographic original printing plate described in the item (7) or (8), wherein the above-described lower layer further comprises the above described infrared absorbing agent.

(10) A method of making a planographic printing plate, comprising, in the following order:
subjecting the recording layer of the planographic original printing plate described in any one of the above items <1> to <9> to image-wise exposure; and
developing the planographic original printing plate using an alkaline aqueous solution which has a pH of from 8.5 to 10.8.

(11) The method of making a planographic printing plate described in the above item (10), wherein the alkaline aqueous solution comprises an anionic surfactant or a nonionic surfactant.

Hereinafter, the present invention is described in detail.

### <Lithographic Original Printing Plate>

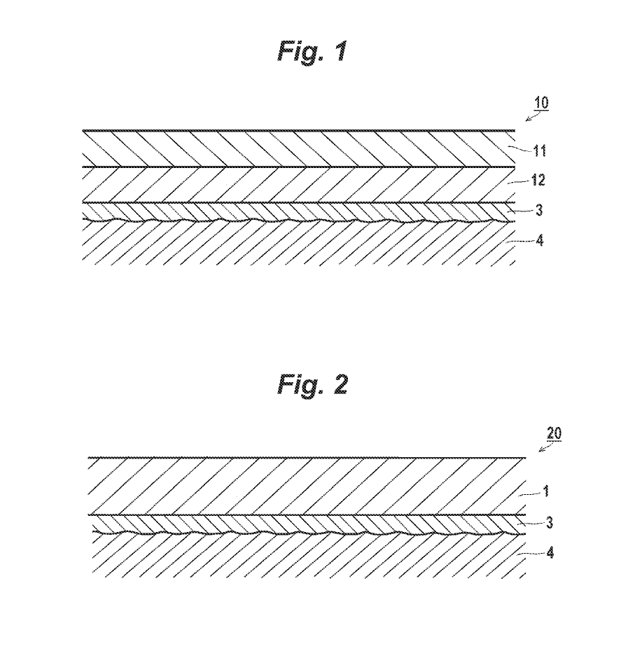

The planographic original printing plate of the present invention contains, in arbitrary layer(s) of the at least one recording layer provided on the support thereof, (A) a star polymer in which at least 3 polymer chains bind to atomic groups that serve as a core and are radially branching, (B) an alkali-soluble resin and (C) an infrared absorbing agent. Herein, in the case where the recording layer has a configuration of two or more layers, each one of the above-described components (A) to (C) may be contained in the same layer, or in separated layers. The layer configuration may be a single layer configuration (see FIG. 2; the image recording layer 1 is provided above the support 4 having thereon the undercoat layer 3), or a multilayer configuration composed of an upper layer and a lower layer (see FIG. 1; the lower layer 12 and the upper layer 11 are provided in this order above the support 4 having thereon the undercoat layer 3). From the viewpoint of development latitude, the layer configuration is preferably a multilayer configuration in which a lower layer that contains an infrared absorbing agent and an upper layer whose solubility with respect to an alkali-aqueous solution is improved by heat are provided sequentially. In this case, (A) the polymer compound in which the main chain has three or more branches may be added to the lower layer, or may be added to the upper layer (see Table 1 shown below for details).

Herein, the expression “are provided sequentially” means that the lower layer and the upper layer are disposed in this order on the support, and if desired, other layers, for example, optional layers such as an undercoat layer or a surface protective layer further may be disposed. From the viewpoint of effects in the present invention, the lower layer and the upper layer are preferably formed adjacent to each other.

Hereinafter, a preferable embodiment of the present invention is described.

((A) Polymer Compound in which the Main Chain has Three or More Branches)

The star polymer used in the present invention in which polymer chains bind to a core and are branching at three or more sites thereof preferably has the structure represented by any one of the following chemical formulae. These polymers have the structures in which one end of the polymer chain P1 binds to the central skeleton (core) A, and accordingly they are different from a graft type polymer in which one end of a polymer side chain binds to a polymer main chain.

From this point of view, the core A of the star polymer is not composed of one carbon atom (C), but preferably composed of an atomic group having molecular weight of from 100 to 1,500, more preferably an atomic group having molecular weight of from 200 to 1,000, and most preferably an atomic group having molecular weight of from 300 to 800. From a different aspect, the core A preferably has a symmetry structure. Herein, the term “symmetry structure” is referred to as a structure which results in an original structure being formed by a rotation operation, a mirror operation, an inversion operation, or a combination thereof. However, any strict consistency of the symmetric property is not needed, and there may be a portion that has misalignment of the symmetric shape, as long as the effect of the present invention is achieved. In other words, the core A is preferably an atomic group that has three or more unitable sites from which bonds are radiating. Further from the viewpoint of development latitude, it is preferable for the core A to be derived from a sulfur-containing chain transfer agent. It is assumed that if the molecular weight of the core A is less than or equal to 100, it becomes a disadvantage to reactivity in the time when the star polymer is produced, meanwhile if the molecular weight of the core A is more than or equal to 1,500, the structure of the core A is likely to have misalignment of a spherical structure, and a net-like structure increases, which results in a disadvantage to the effect on the development latitude.

From the same points of view, the polymer chain P1 is preferably composed of an atomic group having a molecular weight of from 1,000 to 1,000,000, more preferably from 3,000 to 500,000, and most preferably from 5,000 to 100,000. Further, the polymer side chain preferably has a structure composed of polyolefin as a main chain, and more preferably a structure including a secondary side chain having a hydrophilic group.

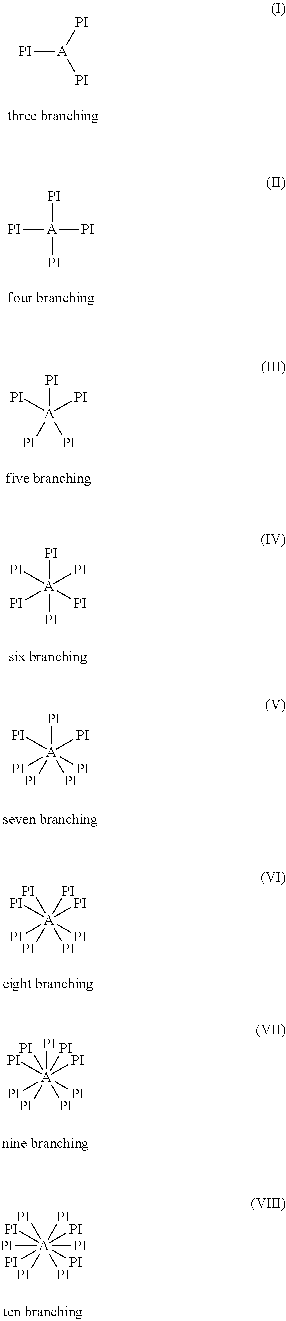

The reason of the effects (action mechanism) that can be achieved by using the star polymer in the present invention may be described as follows, although still not fully understood. Ordinarily, effects on enhancement of plate durability and chemical resistance in the recording layer of the original plate may be expected by using a polymer. On the other hand, the use of the polymer may inhibit the permeation of a developing solution, and may become a factor for reduction in developability. In contrast, it is presumed that the use of the star polymer makes it possible to realize a good developability without inhibiting the permeation of a developing solution, and rather by promoting developability due to the molecular structure of the star polymer that is difficult for its molecular network to expand, while maintaining advantages of the plate durability and the chemical resistance each of which the polymer originally may exert. It is thought that this enables to realize satisfaction of a high degree of development latitude, chemical resistance and plate durability at the same time, which is ordinarily difficult to achieve, and further, if needed, to realize improvement in development with a low pH developing solution and improvement in stability after printing.

As for the star polymer used in the present invention, any one of star polymers may be used, as long as it has the above-described structure. Examples of such star polymers include: star polymers that can be obtained by a coupling process or an anion growth method described in Shin Jikken Kagaku Koza Kobunshi Kagaku I, edited by The Chemical Society of Japan, pp. 208-210; star polymers that can be obtained by a synthetic method described in JP-A-10-27986 in which a polymerization reaction is conducted under light irradiation using a compound containing a dithiocarbamate group and/or a compound containing a xanthate group as an initiator; and star polymers that can be obtained by an ordinary radical polymerization using a multifunctional thiol as a chain transfer agent. From the viewpoints of ease in synthesis and properties of the obtained polymer, the star polymers that can be obtained by an ordinary radical polymerization using a multifunctional thiol as a chain transfer agent are preferable. Examples of such star polymers include those having a multifunctional thiol as a core (A), and polymer chains (P1) binding to the core through sulfide bonds.

As for the multifunctional thiol that can be used in synthesis of the star polymer as a raw material compound that forms the nucleous of the star polymer in the present invention, any one of multifunctional thiols may be favorably used, as long as it has a plurality of thiols in one molecule thereof. Multifunctional thiols having from 3 functions to 10 functions are preferable. Three-to eight-functional thiols are more preferable. Four-to six-functional thiols are especially preferable. Preferable examples of the multifunctional thiols are exemplified below.

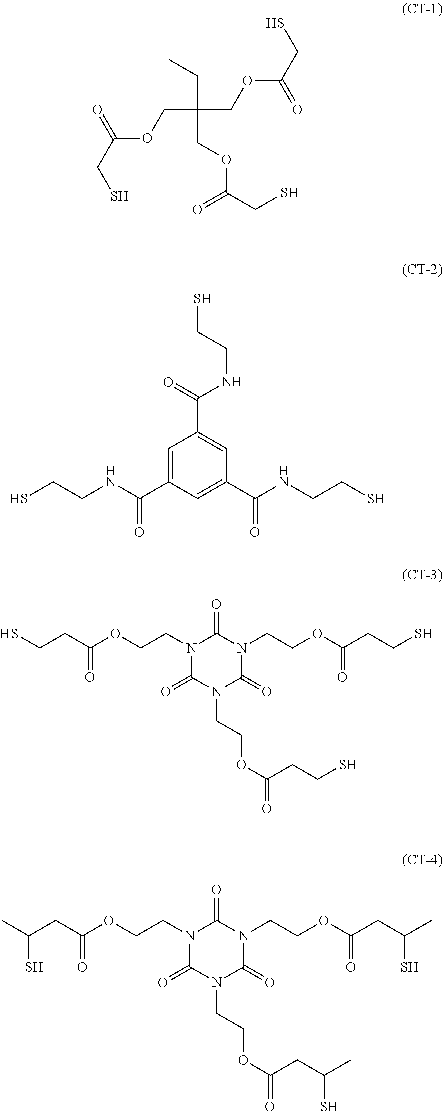

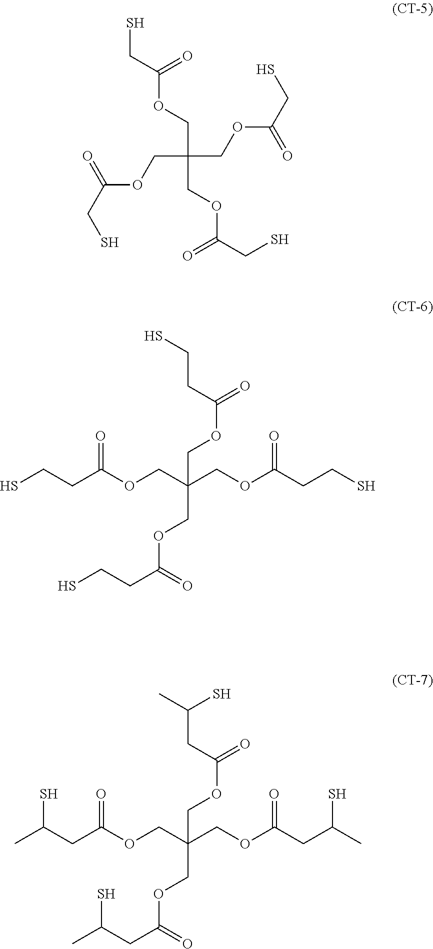

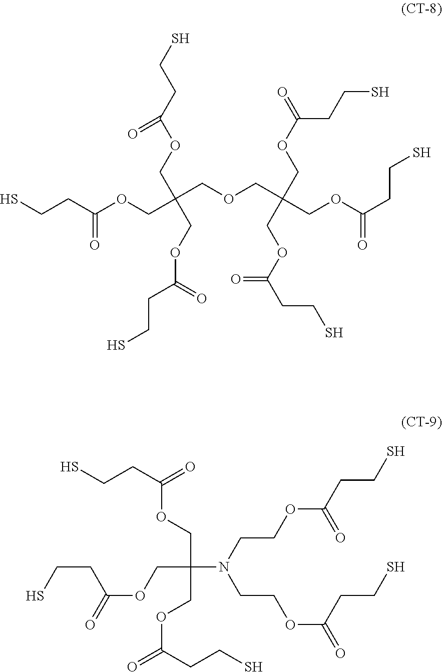

Among the above structures, from the view of developability, the structures of (CT-5), (CT-6), (CT-7) and (CT-8) are preferable.

The star polymer used in the present invention is a polymer compound having a multifunctional thiol like those described above as a core (A), and polymer chains (P1) binding to the core through sulfide bonds. Examples of the polymer chain in the star polymer used in the present invention include known vinyl based polymers, (meth) acrylic acid-based polymers, and styrene based polymers that can be produced by radical polymerization. Especially, (meth) acrylic acid-based polymers and styrene based polymers are preferable.

One preferable example of the polymer chain used in the present invention includes a copolymer having a recurring unit containing a hydrophilic group. Examples of the hydrophilic group include a sulfonamide group, a carboxylic acid (salt) group, a sulfonic acid (salt) group, a hydroxyl group, a carboxylic acid amide group, a sulfuric acid (salt) group, a carbobetaine group, a sulfobetaine group, a phosphobetaine group, an N-oxide group, an ammonium group, —(CH₂CH₂O)ₙR, —(C₃H₆O)ₘR (R represents a hydrogen atom, an alkyl group having 1 to 12 carbon atoms, an aryl group, an alkenyl group, or an alkynyl group; n and m each represent an integer of from 1 to 100), and a combination of these groups.

Among these hydrophilic functional groups, a sulfonamide group, a carboxylic acid (salt) group, a sulfonic acid (salt) group, a carboxylic acid amide group, a carbobetaine group, a sulfobetaine group, a phosphobetaine group, and —(CH₂CH₂O)ₙR are preferable. A sulfonamide group, a carboxylic acid (salt) group and a carboxylic acid amide group are more preferable.

The polymer side chain P1 represented by any one of the above-described formulae (I) to (VIII) is preferably those derived from a compound selected from the group consisting of compounds represented by the following formulae (A) to (C).

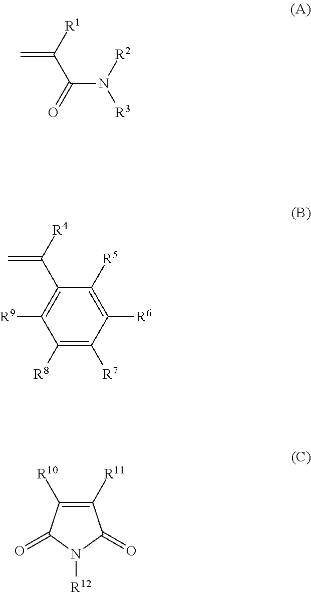

In formulae (A) to (C), R¹ and R⁴ represent a hydrogen atom or a methyl group; R², R³, R⁵ to R¹² each independently represents a hydrogen atom or a monovalent organic group; and R² and R³, and R¹⁰ and R¹¹ may bind to each other to form a ring.

Examples of a monovalent organic group include an alkyl group which may have a substituent and an aryl group which may have a substituent.

Especially, as R², R³ and R¹², a hydrogen atom, an unsubstituted alkyl group or aryl group, and an alkyl group or aryl group each of which has an acidic hydrogen atom as a substituent are preferable. An aryl group having an acidic hydrogen atom is more preferable. As the substituent having an acidic hydrogen atom, a carboxylic acid group and a sulfonic acid group are preferable.

Specific examples of the raw material compounds that form the side chain P1 of the star polymer used in the present invention and also form a polymer unit having a hydrophilic group are shown below. However, the present invention is not limited to these compounds.

Note that in the present specification, when an x x x group is described relating to a substituent, the x x x group may have an arbitrary substituent. Further, in the case where there are plural groups that are indicated by the same reference numeral, these groups may be the same or different. In the case where plural groups are connected to form a ring, all of the plural groups may be connected, or a part of the plural groups may be connected.

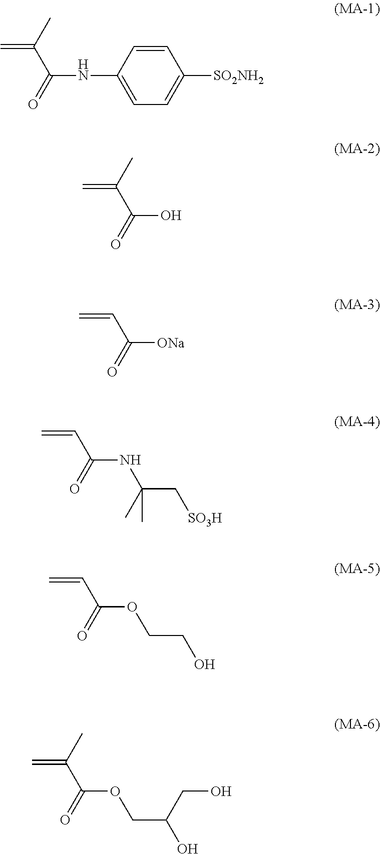

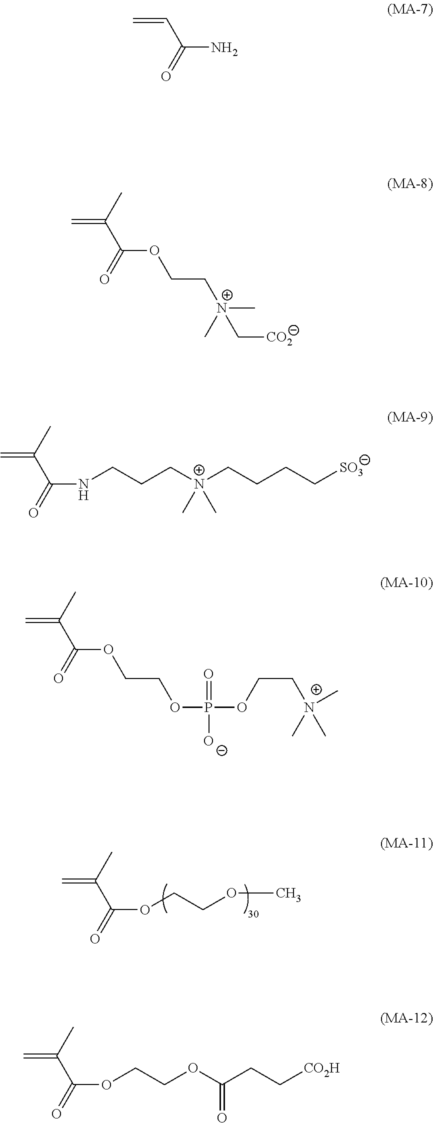

Among the above structures, from the view of developability and chemical resistance, the structures of (MA-1), (MA-2) and (MA-7) are particularly preferable, the structures of (MA-1) and (MA-7) are more preferable.

These hydrophilic groups are preferably contained in a range of from 0.5 m mole/g to 50 m mole/g, more preferably from 1.0 m mole/g to 30 m mole/g, and especially more preferably from 1.5 m mole/g to 10 m mole/g, with respect to 1 g of the star polymer. If the content of the hydrophilic group is less than or equal to 0.5 m mole/g, concern about deficiency in developability may be caused. Meanwhile, if the content of the hydrophilic group is more than or equal to 50 m mole/g, concern about deterioration of plate durability may be caused.

The polymer chain of the star polymer used in the present invention may have a polymer unit of (meth) acrylic acid alkyl or aralkyl ester, a polymer unit of (meth) acrylamide or derivatives thereof, a polymer unit of α-hydroxymethyl acrylate, styrene derivatives, N-substituted maleimide derivatives, or a polymer unit of (meth) acrylonitrile in addition to the above-described polymer unit having a hydrophilic group. The alkyl group of the (meth) acrylic acid alkyl ester is preferably an alkyl group having 1 to 5 carbon atoms, and more preferably a methyl group, an ethyl group, an n-butyl group, an isobutyl group, or a tert-butyl group. Examples of the (meth) acrylic acid aralkyl ester include benzyl (meth) acrylate. Examples of the (meth) acrylamide derivatives include N-isopropyl (meth) acrylamide, N-phenyl (meth) acrylamide, N-(4-methoxycarbonylphenyl) (meth) acrylamide, N, N-dimethyl (meth) acrylamide, and morpholino (meth) acrylamide. Examples of the α-hydroxymethyl acrylate include ethyl α-hydroxymethyl acrylate, and cyclohexyl α-hydroxymethyl acrylate. Examples of the styrene derivatives include styrene, and 4-tert-butyl styrene. Examples of the N-substituted maleimide derivatives include N-methyl maleimide, N-ethyl maleimide, and N-phenyl maleimide.

Specific examples of the polymer unit other than the polymer unit having a hydrophilic group of the star polymer used in the present invention are shown below. However, the present invention is not limited to these compounds.

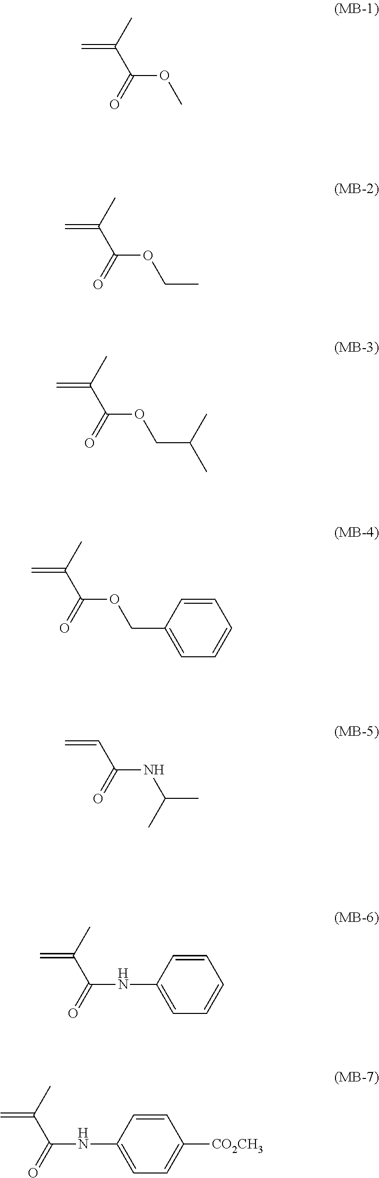

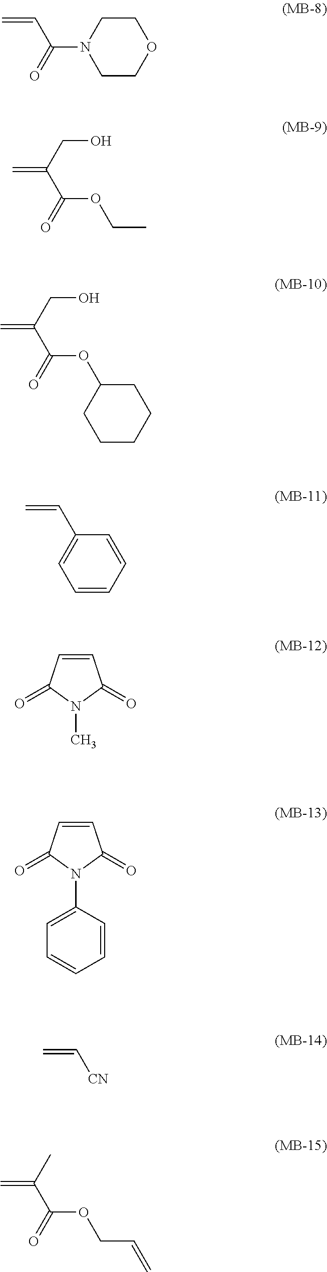

Among the above structures, from the view point of plate durability, the structures of (MB-1), (MB-2), (MB-3), (MB-11), (MB-12), (MB-13) and (MB-14) are particularly preferable and the structures of (MB-11), (MB-12), (MB-13) and (MB-14) are most preferable.

The mass average molecular weight of the star-shaped polymer used in the present invention is preferably 5,000 to 500,000, more preferably 10,000 to 250,000. The specific examples of the star-shaped polymer used in the present invention are described below. However, the present invention is not limited thereto.

In the present invention, the term “molecular weight” means mass average molecular weight, unless otherwise specified. Molecular weight and dispersity are values measured by the following method.

### [Method of Measuring Molecular Weight and Dispersity]

The molecular weight and degree of dispersion are measured using GPC (gel permeation chromatography) method, unless otherwise specified. The gel packed in the column used for GPC method is preferably a gel having an aromatic compound in the repeating unit, and examples thereof include a gel comprising a styrene-divinylbenzene copolymer. Two to six columns are preferably connected and used. The solvent used includes an ether-based solvent such as tetrahydrofuran, and an amide-based solvent such as N-methylpyrrolidinone. The measurement is preferably performed at a solvent flow rate of 0.1 to 2 mL/min, most preferably from 0.5 to 1.5 mL/min. When the measurement is performed in this range, the measurement can be performed more efficiently without imposing a load on the apparatus. The measurement temperature is preferably from 10° C. to 50° C., and most preferably from 20° C. to 40° C. The column and the carrier used in this measurement may be selected appropriately in accordance with physical properties of the polymer to be measured.

| | | Thiol | Hydrophilic | Hydrophilic | Other | Other | Molecular weight |
|---|---|---|---|---|---|---|---|
| | Number | compound | monomer I | monomer II | monomer I | monomer II | (Ten thousand) |
| Function | | | | | | | |
| Number | | | | | | | |
| 3 | P-1 | CT-1 | MA-1 | | MB-1 | MB-14 | 5.5 |
| | | 2 | 36 | | 32 | 30 | |
| 3 | P-2 | CT-2 | MA-1 | | MB-1 | MB-14 | 5.5 |
| | | 2 | 36 | | 32 | 30 | |
| 3 | P-3 | CT-3 | MA-1 | | MB-1 | MB-14 | 5.5 |
| | | 2 | 36 | | 32 | 30 | |
| 3 | P-4 | CT-4 | MA-1 | | MB-1 | MB-14 | 5.5 |
| | | 2 | 36 | | 32 | 30 | |
| 4 | P-5 | CT-5 | MA-1 | | MB-1 | MB-14 | 5.4 |
| | | 1.5 | 36 | | 32 | 30.5 | |
| 4 | P-6 | CT-6 | MA-1 | | MB-1 | MB-14 | 5.4 |
| | | 1.5 | 36 | | 32 | 30.5 | |
| 4 | P-7 | CT-7 | MA-1 | | MB-1 | MB-14 | 5.4 |
| | | 1.5 | 36 | | 32 | 30.5 | |
| 6 | P-8 | CT-8 | MA-1 | | MB-1 | MB-14 | 5.2 |
| | | 1 | 36 | | 32 | 31 | |
| 6 | P-9 | CT-8 | MA-1 | | MB-1 | MB-14 | 6.5 |
| | | 0.5 | 36 | | 32 | 31.5 | |
| 6 | P-10 | CT-8 | MA-1 | | MB-1 | MB-14 | 4.0 |
| | | 2 | 36 | | 32 | 30 | |
| 6 | P-11 | CT-8 | MA-2 | | MB-1 | MB-14 | 5.2 |
| | | 1 | 36 | | 32 | 31 | |
| 6 | P-12 | CT-8 | MA-2 | MA-3 | MB-1 | MB-14 | 5.0 |
| | | 1 | 26 | 10 | 32 | 31 | |
| 6 | P-13 | CT-8 | MA-2 | MA-4 | MB-1 | MB-14 | 5.3 |
| | | 1 | 26 | 10 | 32 | 31 | |
| 6 | P-14 | CT-8 | MA-2 | MA-5 | MB-1 | MB-14 | 5.1 |
| | | 1 | 26 | 10 | 32 | 31 | |
| 6 | P-15 | CT-8 | MA-2 | MA-6 | MB-1 | MB-14 | 5.0 |
| | | 1 | 26 | 10 | 32 | 31 | |
| 6 | P-16 | CT-8 | MA-2 | MA-7 | MB-1 | MB-14 | 5.0 |
| | | 1 | 26 | 10 | 32 | 30 | |
| 6 | P-17 | CT-8 | MA-2 | MA-8 | MB-1 | MB-14 | 5.1 |
| | | 1 | 26 | 10 | 32 | 31 | |
| Functional | | | | | | | |
| Number | | | | | | | |
| 6 | P-18 | CT-8 | MA-2 | MA-9 | MB-1 | MB-14 | 5.0 |
| | | 1 | 26 | 10 | 32 | 31 | |
| 6 | P-19 | CT-8 | MA-2 | MA-10 | MB-1 | MB-14 | 5.2 |
| | | 1 | 26 | 10 | 32 | 31 | |
| 6 | P-20 | CT-8 | MA-2 | MA-11 | MB-1 | MB-14 | 5.0 |
| | | 1 | 26 | 10 | 32 | 31 | |
| 6 | P-21 | CT-8 | MA-12 | | MB-1 | MB-14 | 5.0 |
| | | 1 | 36 | | 32 | 31 | |
| 6 | P-22 | CT-8 | MA-2 | | MB-1 | | 5.2 |
| | | 1 | 20 | | 79 | | |
| 6 | P-23 | CT-8 | MA-2 | | MB-2 | MB-3 | 5.1 |
| | | 1 | 29 | | 55 | 15 | |
| 6 | P-24 | CT-8 | MA-2 | | MB-2 | MB-4 | 5.2 |
| | | 1 | 29 | | 55 | 15 | |
| 6 | P-25 | CT-8 | MA-2 | | MB-5 | MB-15 | 5.1 |
| | | 1 | 30 | | 20 | 49 | |
| 6 | P-26 | CT-8 | MA-2 | | MB-6 | MB-15 | 5.0 |
| | | 1 | 30 | | 20 | 49 | |
| 6 | P-27 | CT-8 | MA-2 | | MB-7 | MB-15 | 5.0 |
| | | 1 | 30 | | 20 | 49 | |
| 6 | P-28 | CT-8 | MA-2 | | MB-8 | MB-15 | 5.2 |
| | | 1 | 30 | | 20 | 49 | |
| 6 | P-29 | CT-8 | MA-2 | | MB-9 | MB-15 | 5.1 |
| | | 1 | 30 | | 20 | 49 | |
| 6 | P-30 | CT-8 | MA-2 | | MB-10 | MB-15 | 5.1 |
| | | 1 | 30 | | 20 | 49 | |
| 6 | P-31 | CT-8 | MA-2 | | MB-11 | MB-14 | 5.2 |
| | | 1 | 25 | | 50 | 24 | |
| 6 | P-32 | CT-8 | MA-2 | | MB-11 | MB-12 | 5.3 |
| | | 1 | 25 | | 50 | 24 | |
| 6 | P-33 | CT-8 | MA-2 | | MB-11 | MB-13 | 5.1 |
| | | 1 | 25 | | 50 | 24 | |
| 6 | P-34 | CT-8 | MA-2 | MA-7 | MB-13 | | 5.0 |
| | | 1 | 25 | 25 | 49 | | |

Note)
In Table, values in lower shelf represent mol %.

The star polymer used in the present invention may be used in a single use of 1 kind, or in a mixture of two kinds or more.

The content of the star polymer in the image recording layer is preferably in a range of from 5% by mass to 90% by mass, and more preferably from 10% by mass to 70% by mass, with respect to the total solid content thereof. If this content is the above-described upper limit or less, excellent development latitude can be achieved, meanwhile if this content is the above-described lower limit or more, excellent plate durability can be achieved.

The structures or constitutions of the star polymer can be identified in accordance with identification methods such as NMR spectral analysis, MS analysis, or elemental analysis. Further, the branching degree can be calculated in accordance with the method described on page 62 of Daigakuin Kobunshi Kagaku (Graduate School Polymer Science), published by Kodansha Scientific Ltd. and edited by Takuhei Nose, Seiichi Nakahama and Seizo Miyata.

### ((B) Alkali-Soluble Resin)

In the present invention, an arbitrary layer above the support contains an alkali-soluble resin. The alkali-soluble resin is preferably a novolac resin. Examples thereof include novolak resin such as phenol formaldehyde resin, m-cresol formaldehyde resin, p-cresol formaldehyde resin, m-/p-mixture cresol formaldehyde resin, phenol/cresol (any of m-, p-, or m-/p-mixed may be used) mixed formaldehyde resin or the like, and pyrogallol acetone resin.

In the present invention, the content of the alkali-soluble resin is preferably in a range of from more than 0% by mass to less than or equal to 98% by mass, and more preferably from 1% by mass to 50% by mass, with respect to the total solid content of the layer. Further, the content of the alkali-soluble resin is preferably in a range of from more than 0 parts by mass to less than or equal to 90 parts by mass, and more preferably from 5 parts by mass to 50 parts by mass, with respect to 100 parts of (A) the star polymer. If this content is the above-described upper limit or less, excellent development latitude and chemical resistance can be achieved, meanwhile if this content is the above-described lower limit or more, excellent plate durability can be achieved.

### ((C) Infrared Absorbing Agent)

The recording layer of the planographic original printing plate according to the present invention preferably contains an infrared absorbing agent. The infrared absorbing agent is not particularly limited as long as it is a dye that absorbs infrared light and generates heat, and various dyes known as infrared absorbing agents may be used.

As the dye, known dyes which are commercially available or are described in the literature (for example, “Senryobinran (Dye Handbook)” edited by Yukigoseikagaku Kyokai, published in 1970) may be utilized. More particularly, dyes such as an azo dye, a metal complex azo dye, a pyrazolone azo dye, an anthraquinone dye, a phthaocyanine dye, a carbonium dye, a quinoneimine dye, a methine dye, a cyanine dye and the like are exemplified are specified. In the present invention, among these dyes, those capable of absorbing at least an infrared light or a near-infrared light are preferred as suitable for use with a laser that emits an infrared light or a near-infrared light. Especially, cyanine dyes are preferable.

Dyes absorbing at least infrared or near infrared light include cyanine dyes described in Japanese Patent Application Laid-Open (JP-A) Nos. 58-125246, 59-84356, 59-202829, 60-78787 and the like, methine dyes described in Japanese Patent Application Laid-Open (JP-A) Nos. 58-173696, 58-181690, 58-194595 and the like, naphthoquinone dyes described in Japanese Patent Application Laid-Open (JP-A) Nos. 58-112793, 58-224793, 59-48187, 59-73996, 60-52940, 60-63744 and the like, squarylium dyes described in Japanese Patent Application Laid-Open (JP-A) No. 58-112792 and the like, cyanine dyes described in GB 434,875 and the like.

In addition, near infrared absorbing sensitizers described in U.S. Pat. No. 5,156,938 are suitably used. A substituted arylbenzo (thio) pyrylium salt described in U.S. Pat. No. 3,881,924, trimethinethiapyrylium salt described in Japanese Patent Application Laid-Open (JP-A) No. 57-142645 (U.S. Pat. No. 4,327,169), pyrylium compounds described in Japanese Patent Application Laid-Open (JP-A) Nos. 58-181051, 58-220143, 59-41363, 59-84248, 59-84249, 59-146063, and 59-146061, a cyanine dye described in Japanese Patent Application Laid-Open (JP-A) No. 59-216146, a pentamethinethipyrylium salt described in U.S. Pat. No. 4,283,475, and the like, pyrylium compounds described in Japanese Patent Application Publication (JP-B) Nos. 5-13514 and 5-19702, Epolight III-178, Epolight III-130, Epolight III-125 and the like are also particularly preferably used.

Further, other examples of preferable dyes are near-infrared absorbing dyes which are represented by the formulae (I) and (II) described in U.S. Pat. No. 4,756,993.

In the present specification, the *** compound means to embrace the compound itself, and in addition thereto, a salt thereof and an ion or the like thereof. Typically, this compound means the compound and/or a salt thereof.

Among these dyes, particularly preferred examples include cyanine dyes, phthalocyanine dyes, oxonol dyes, squarylium dyes, pyrylium salts, thiopyrylium dyes, and nickel thiolate complexes. Further, it is most preferable for the cyanine dye represented by the following Formula (a) to be used in the upper layer of the recording layer according to the present invention because the cyanine dye imparts polymerization activity and exhibits excellent stability and economic efficiency.

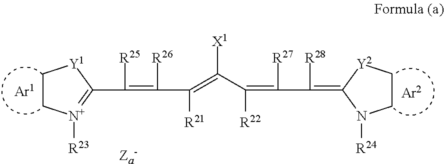

In formula (a), X¹ represents a hydrogen atom, a halogen atom, —NPh₂, -X²-L¹ or a group shown below. X² represents an oxygen atom or a sulfur atom. L¹ represents a hydrocarbon group having from 1 to 12 carbon atoms, an aromatic ring containing a hetero atom or a hydrocarbon group having from 1 to 12 carbon atoms and containing a hetero atom. Herein, the hetero atom refers to N, S, O, a halogen atom and Se.

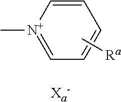

Xa⁻ has the same meaning as Za⁻ defined hereinafter. R^{a} represents a hydrogen atom or a substituent selected from an alkyl group, an aryl group, a substituted or unsubstituted amino group and a halogen atom.

R²¹ and R²² each independently represents a hydrocarbon group having from 1 to 12 carbon atoms. In view of the preservation stability of a coating solution for photosensitive layer, it is preferred that R²¹ and R²² each represent a hydrocarbon group having two or more carbon atoms. Also, R²¹ and R²² may be combined with each other to form a ring and in case of forming the ring, to form a 5-membered or 6-membered ring is particularly preferred.

Ar¹ and Ar², which may be the same or different, each represents an aromatic hydrocarbon group which may have a substituent. Preferable examples of the aromatic hydrocarbon group include a benzene ring group and a naphthalene ring group. Preferable examples of the substituent include a hydrocarbon group having 12 or less carbon atoms, a halogen atom and an alkoxy group having 12 or less carbon atoms.

Y¹ and Y², which may be the same or different, each represents a sulfur atom or a dialkylmethylene group having 12 or less carbon atoms. R²³ and R²⁴, which may be the same or different, each represents a hydrocarbon group having 20 or less carbon atoms, which may have a substituent. Preferable examples of the substituent include an alkoxy group having 12 or less carbon atoms, a carboxyl group and a sulfo group.

R²⁵, R²⁶, R²⁷ and R²⁸, which may be the same or different, each represents a hydrogen atom or a hydrocarbon group having 12 or less carbon atoms. From the standpoint of the availability of raw materials, a hydrogen atom is preferred. Za⁻ represents a counter anion. However, Za⁻ is not necessary when the cyanine dye represented by formula (a) has an anionic substituent in the structure thereof and the neutralization of charge is not needed. Preferable examples of the counter ion for Za⁻ include a halide ion, a perchlorate ion, a tetrafluoroborate ion, a hexafluorophosphate ion and a sulfonate ion, and particularly preferable examples thereof include a perchlorate ion, a hexafluorophosphate ion and an arylsulfonate ion in view of the preservation stability of a coating solution for photosensitive layer.

Specific examples of the cyanine dye represented by formula (a) which can be preferably used in the invention include compounds described in Paragraph Nos. [0017] to [0019] of JP-A-2001-133969, Paragraph Nos. [0012] to [0037] of JP-A-2002-40638 and Paragraph Nos. [0012] to [0023] of JP-A-2002-23360.

Particularly preferred dye is cyanine dye A below.

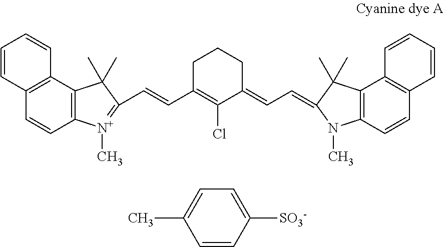

The amount of infrared absorbing agent added is preferably 0.01 to 50% by mass relative to the total solids content of the layer, more preferably 0.1 to 30% by mass, and particularly preferably 1.0 to 30% by mass. If the addition amount is equal to or more than 0.01% by mass, high sensitivity is achieved. Meanwhile, if the addition amount is equal to or less than 50% by mass, a high degree of uniformity of the layer is obtained and the layer has the quality to last long.

### <Configuration of Recording Layer>

The case where the recording layer has a layered structure is mainly described below. However, as the layer configuration and the arrangement of the components in a preferable embodiment of the present invention, the following combinations are exemplified.

TABLE 1

| | | Component A | | |
|---|---|---|---|---|
| | | Star-shaped | Component B | Component C |
| | | polymer | Novolac resin | IR absorbent |
| Single layer | | ◯ | ◯ | ◯ |
| Multiple | Upper | ◯*¹ | ◯ | |
| layers | layer | | | |
| | Lower | ◯*² | | ◯ |
| | layer | | | |

*¹Examples 2 and 4 described below
*²Example 3 described below

### <Lower Layer in the Case of Layered Structure>

The lower layer in the case of a layered structure preferably contains the above-described infrared absorbing agent (C). If desired, the lower layer may contain other components, as long as they undermine the effectiveness of the present invention. Examples of the other components include (A) star polymer, and (B) alkali-soluble resin having a different structure from the novolac resin (this resin is referred to as “other alkali-soluble resin”).

### (Other Alkali-Soluble Resin)

In the present invention, the term “alkali-soluble” means that the resin is soluble in an alkaline solution with a pH of from 8.5 to 13.5 by a processing of a standard developing time. The other alkali-soluble resin used in the lower layer is not limited in particular, as long as the resin has a predisposition to be dissolved in contact with an alkaline developing solution. The resin has preferably an acidic functional group such as a phenolic hydroxyl group, a sulfonic acid group, a phosphoric acid group, a sulfonamide group, or an active imide group, at a main chain and/or side chain of the polymer. Examples of the resin include a resin including a monomer having such an acid functional group that imparts alkali solubility, in an amount of 10% by mole or more, and more preferably 20% by mole or more as a component thereof, When the copolymerization component of the monomer that imparts alkali solubility is at least 10 mole %, sufficient alkali solubility is obtained and developability is excellent.

Furthermore, as described in U.S. Pat. No. 4,123,279, a condensation polymer between formaldehyde and a phenol having as a substituent an alkyl group having 3 to 8 carbon atoms, such as a t-butylphenol formaldehyde resin or an octylphenol formaldehyde resin can be cited. The weight-average molecular weight thereof (Mw) is preferably at least 500, and more preferably 1,000 to 700,000. The number-average molecular weight thereof (Mn) is preferably at least 500, and more preferably 750 to 650,000. The dispersity (weight-average molecular weight/number-average molecular weight) is preferably 1.1 to 10.

The other alkali-soluble resin preferably has a weight-average molecular weight of at least 2,000 and a number-average molecular weight of at least 500, and more preferably a weight-average molecular weight of 5,000 to 300,000 and a number-average molecular weight of 800 to 250,000. The other alkali-soluble resin preferably has a dispersity (weight-average molecular weight/number-average molecular weight) of 1.1 to 10.

In the planographic original printing plate, with regard to the other alkali-soluble resin, one type may be used on its own or two or more types may be used in combination.

The other alkali-soluble resin may be used in an amount such that the content of the other alkali-soluble resin is from 0% by mass to 98% by mass with respect to the total solid content. The other alkali-soluble resin may be contained in a proportion of 80 parts by mass or less with respect to 100 parts by mass of the above-described star-shaped polymer (A).

### <Upper Layer in the Case of Layered Structure>

The mechanisms to improve solubility with respect to an alkali-aqueous solution by heat in the upper layer are not particularly limited. Any one of the upper layers may be used, as long as the upper layer contains a binder resin whereby solubility of a heated region is improved. Examples of heat used for image formation include heat that is generated in the case where the lower layer containing an infrared absorbing agent is exposed.

Examples of the upper layers in which alkali-solubility of a heated region is improved by heat include: a layer containing an alkali-soluble resin having a hydrogen bond ability, such as novolac or urethane; a layer containing both a water-insoluble and alkali-soluble resin and a compound having a suppressive action on dissolution; and a layer containing a compound capable of causing ablation.

Further in the upper layer, heat generated by adding an infrared absorbing agent to the upper layer can be used for image formation. Examples of the constitution of the upper layer containing an infrared absorbing agent include: a layer containing an infrared absorbing agent, a water-insoluble and alkali-soluble resin and a compound having a suppressive action on dissolution; and a layer containing an infrared absorbing agent, a water-insoluble and alkali-soluble resin and a compound that generates an acid by heat.

Hereinafter, components contained in an upper layer are explained.

### (Water-Insoluble and Alkali-Soluble Resin)

The planographic original printing plate of the present invention preferably comprises a water-insoluble and alkali-soluble resin in the upper layer. By containing the alkali-soluble resin, an interaction between the infrared absorbing agent and polar groups that the alkali-soluble resin has is formed whereby a positive-type photosensitive layer is formed. With the inclusion of the above-described exemplified resins, preferable examples of the alkali-soluble resin include polyamide resins, epoxy resins, polyacetal resins, acrylic resins, methacrylic resins, polystyrene resins, and novolac phenol resins.

The alkali-soluble resin that can be used in the present invention is not particularly limited as long as it has the property of dissolving upon contact with an alkaline developer, and is preferably a homopolymer containing an acidic group in the main chain and/or a side chain of the polymer, a copolymer thereof, or a mixture thereof.

Such an acidic group-containing alkali-soluble resin preferably has a functional group such as a phenolic hydroxy group, a carboxy group, a sulfonic acid group, a phosphoric acid group, a sulfonamide group, or an active imide group. Therefore, such a resin may be suitably formed by copolymerization of a monomer mixture comprising one or more ethylenically unsaturated monomers containing the above-mentioned functional groups. Preferred examples of the functional group-containing ethylenically unsaturated monomer include acrylic acid, methacrylic acid, a compound represented by the formula below, and a mixture thereof. In the formula below, R⁴ represents a hydrogen atom or a methyl group.

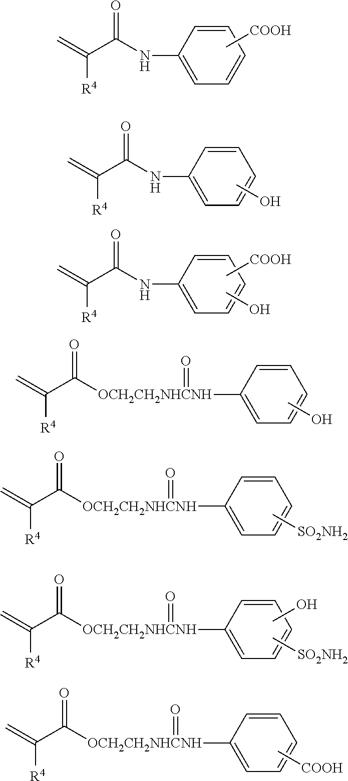

The alkali-soluble resin that can be used in the present invention is preferably a polymer compound obtained by copolymerizing, in addition to the above-mentioned polymerizable monomer, another polymerizable monomer. With regard to the copolymerization ratio in this case, it is preferable for at least 10 mole % of a monomer that imparts alkali solubility such as a monomer comprising a functional group such as a phenolic hydroxy group, a carboxy group, a sulfonic acid group, a phosphoric acid group, a sulfonamide group, or an active imide group to be contained, and it is more preferable for at least 20 mole % to be contained. When the copolymerization component of the monomer that imparts alkali solubility is at least 10 mole %, sufficient alkali solubility is obtained and developability is excellent. Although the upper limit of the content of the monomer that imparts alkali solubility is not limited, it is practical that the content of the monomer that imparts alkali solubility is 50 mole % or less.

Examples of another polymerizable monomer that can be used include the following compounds: alkyl acrylates and alkyl methacrylates, such as methyl acrylate, ethyl acrylate, propyl acrylate, benzyl acrylate, methyl methacrylate, ethyl methacrylate, cyclohexyl methacrylate, and benzyl methacrylate; acrylates and methacrylates having an aliphatic hydroxyl group, such as 2-hydroxyethyl acrylate and 2-hydroxyethyl methacrylate; acrylamides and methacrylamides, such as acrylamide, methacrylamide, N-methylacrylamide, N-ethyl acrylamide, and N-phenyl acrylamide; vinyl esters such as vinyl acetate, vinyl chloroacetate, vinyl butylate, and vinyl benzoate; styrenes such as styrene, .alpha.-methyl styrene, methyl styrene, and chloromethylstyrene; other nitrogen atom-containing monomers such as N-vinylpyrrolidone, N-vinylpyridine, acrylonitrile, and methacrylonitrile; and maleimides such as N-methylmaleimide, N-ethylmaleimide, N-propyl maleimide, N-butyl maleimide, N-phenyl maleimide, N-2-methylphenyl maleimide, N-2,6-diethylphenyl maleimide, N-2-chlorophenyl maleimide, N-cyclohexyl maleimide, N-lauryl maleimide, and N-hydroxyphenyl maleimide.

Among these ethylenically unsaturated other monomers, (meth) acrylates, (meth) acrylamides, maleimides, and (meth) acrylonitrile are preferred.

Furthermore, as the alkali-soluble resin, a novolac resin can be cited preferably as an example.

The water-insoluble and alkali-soluble resin preferably has a weight average molecular weight of 2,000 or more, and a number average molecular weight of 500 or more, and more preferably has a weight average molecular weight of from 5,000 to 300,000, a number average molecular weight of from 800 to 250,000, and a dispersivity (i.e., weight average molecular weight/number average molecular weight) of from 1.1 to 10.

The alkali-soluble resin (A) in an upper layer of a recording layer of the present invention may be used alone, or in combination of two or more thereof.

The content of the alkali-soluble resin with respect to the total solid content of the upper layer in the present invention is preferably from 2.0% by mass to 99.5% by mass, more preferably from 10.0% by mass to 99.0% by mass, and still more from 20.0% by mass to 90.0% by mass. If the content is 2.0% by mass or more, a good durability of the recording layer (photosensitive layer) is achieved. Meanwhile, if the content is 99.5% by mass or less, the recording layer has high sensitivity as well as a good durability.

### (Acid-Generating Agent)

The upper layer of the image recording layer preferably contains an acid generating agent from the viewpoint of improvement in sensitivity.

In the present invention, the acid generating agent refers to a compound that generates an acid by light or heat, and the compound that decomposes by irradiation of infrared, or heating at 100° C. or more to generate an acid. The generated acid is preferably a strong acid with pKa of 2 or less, such as sulfonic acid or hydrochloric acid. The acid generated from the acid generating agent acts as a catalysis whereby the chemical bond of the above-described acid-degradable group is cleaved to become an acid group by which solubility of the upper layer with respect to an alkali aqueous solution is improved.

Examples of the acid generator that is used together with the foregoing acid-decomposable compound include onium salts such as iodonium salts, sulfonium salts, phosphonium salts, and diazonium salts. Specifically, compounds as described in U.S. Pat. No. 4,708,925 and JP-A-7-20629 can be enumerated. In particular, iodonium salts, sulfonium salts, and diazonium salts, each of which comprises a sulfonic acid ion as a counter ion, are preferred. As the diazonium salts are preferable diazonium compounds as described in U.S. Pat. No. 3,867,147, diazonium compounds as described in U.S. Pat. No. 2,632,703, and diazo resins as described in JP-A-1-102456 and JP-A-1-102457. Also, benzyl sulfonates as described in U.S. Pat. Nos. 5,135,838 and 5,200,544 are preferred. In addition, active sulfonic acid esters and disulfonyl compounds as described in JP-A-2-100054, JP-A-2-100055, and JP-A-9-197671 are preferred. Besides, haloalkyl-substituted S-triazines as described in JP-A-7-271029 are preferred.

The compounds described as “an acid precursor” in the above-described JP-A-8-220752, or the compounds described as “(a) a compound capable of generating an acid by irradiation of activated light rays” in JP-A-9-171254 and the like may be suitably used also as an acid generating agent in the present invention.

Especially from the viewpoint of sensitivity and stability, an onium salt compound is preferably used as the acid generating agent. The onium salt compound is described below.

As for the onium salt compound that may be favorably used in the present invention, compounds which are known as a compound that decomposes by infrared exposure and a heat energy that generates from an infrared absorbing agent by the exposure thereby generating an acid may be exemplified. As for the onium salt compound that may be favorably used in the present invention, from the viewpoint of sensitivity, known thermal polymerization initiators and compounds having the following onium salt structure having a bond that is small in terms of bond dissociation energy may be exemplified.

Examples of the onium salt that may be favorably used in the present invention include diazonium salts, iodonium salts, sulfonium salts, ammonium salts, pyridinium salts, and azinium salts, all of which are known. Especially, salts such as sulfonate, carbonate, BF⁴⁻, PF⁶⁻, or CLO⁴⁻ of triaryl sulfonium, or diaryl iodonium are preferable.

Further, the compounds described as examples of the radical polymerization initiator in paragraph Nos. [0036] to [0045] of JP-A-2008-195018 may be favorably used as an acid-generating agent in the present invention.

Specific examples of the azinium salt compounds include compounds described in paragraph Nos. [0047] to [0056] of JP-A-2008-195018.

Further, compounds having an N—O bond, described in JP-A-63-138345, JP-A-63-142345, JP-A-63-142346, JP-A-63-143537 and JP-B-46-42363 (“JP-B” means an examined publication of Japanese patent application) are also favorably used as an acid generating agent in the present invention.

A preferable addition amount of the acid generating agent, in the case where the acid generating agent is added to an upper layer, is in a range of from 0.01% by mass to 50% by mass, more preferably from 0.1% by mass to 40% by mass, and still more preferably from 0.5% by mass to 30% by mass, with respect to the total solid content of the upper layer. In the above-described range, improvement of sensitivity that is an effect due to addition of the acid generating agent is achieved and generation of a residual film in the non-image area is suppressed at the same time.

### (Acid Proliferator)

An acid proliferator may be added to the upper layer in the present invention.

The acid proliferator in the present invention refers to a compound substituted with a residue of a relatively strong acid and the compound that is easily eliminates in the presence of an acid catalyst to generate a new acid. That is, the acid proliferator decomposes by an acid-catalyzed reaction to generate again an acid (hereinafter referred to as ZOH in formula). One or more acids increase per one reaction whereby an acid concentration increases in an accelerated rate in accordance with a progress of the reaction, which results in tremendously improved sensitivity. The strength of the generated acid is preferably 3 or less, and more preferably 2 or less in terms of acid dissociation constant (pKa). If the acid is weaker than this value, elimination reaction due to an acid catalyst cannot be caused.

Examples of the acid used for such acid catalyst include dichloroacetic acid, trichloroacetic acid, methane sulfonic acid, ethane sulfonic acid, benzene sulfonic acid, p-toluene sulfonic acid, naphthalene sulfonic acid and phenyl sulfonate.

The acid amplifiers described in WO 95/29968, WO 98/24000, JP-A-8-305262, JP-A-9-34106, JP-A-8-248561, JP-T-8-503082, U.S. Pat. No. 5,445,917, JP-T-8-503081, U.S. Pat. No. 5,534,393, U.S. Pat. No. 5,395,736, U.S. Pat. No. 5,741,630, U.S. Pat. No. 5,334,489, U.S. Pat. No. 5,582,956, U.S. Pat. No. 5,578,424, U.S. Pat. No. 5,453,345, U.S. Pat. No. 5,445,917, EP 665,960, EP 757,628, EP 665,961, U.S. Pat. No. 5,667,943, JP-A-10-1598, and the like can be used individually or in combination as the acid amplifier according to the present invention.

The preferably specific examples of the acid amplifiers in the present invention include compounds described in, for example, the paragraph Nos. [0056] to [0067] of JP-A-2001-66765.

An addition amount of the acid proliferator, in the case where the acid proliferator is added to an upper layer, is generally in a range of from 0.01% by mass to 20% by mass, preferably from 0.01% by mass to 10% by mass, and more preferably from 0.1% by mass to 5% by mass, with respect to the total solid content of the upper layer. If the addition amount of the acid proliferator is in the above-described range, a sufficient effect on the addition amount of the acid proliferator is obtained whereby improvement in sensitivity is achieved.

### (Other Additives)

When forming the lower layer and the upper layer, in addition to the above-mentioned components, various additives may be added as necessary as long as the effects of the present invention are not impaired. The additives cited below may be added only to the lower layer, only to the upper layer, or to both layers.

### (Development Accelerator)

For the purpose of improving the sensitivity, acid anhydride, phenols, or organic acids may be added to the upper layer and/or the lower layer.

The acid anhydride is preferably a cyclic acid anhydride, and specific examples of the cyclic acid anhydride include phthalic, tetrahydrophthalic anhydride, hexahydrophthalic anhydride, 3,6-endooxytetrahydrophthalic anhydride, tetrachlorophthalic anhydride, maleic anhydride, chloromaleic anhydride, .α-phenylmaleic anhydride, succinic anhydride, and pyromellitic anhydride anhydride described in U.S. Pat. No. 4,115,128. As an acyclic acid anhydride, acetic anhydride, etc. can be cited.

Examples of the phenols include bisphenol A, 2,2′-bishydroxysulfone, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane, etc.

As the organic acids, there are those described in JP-A-60-88942, JP-A-2-96755, etc., and specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

The ratio of the acid anhydride, the phenols, and the organic acids relative to the total solids content of the lower layer or the upper layer is preferably 0.05 to 20% by mass, more preferably 0.1 to 15% by mass, and particularly preferably 0.1 to 10% by mass.

### (Surfactant)

In order to improve coating properties, and further to broaden latitude of the processing stability to variations of development conditions, non-ionic surfactants described in JP-A-62-251740 and JP-A-3-208514, amphoteric surfactants described in JP-A-59-121044 and JP-A-4-13149, and fluorine-containing monomer-based copolymers described in JP-A-62-170950, JP-A-11-288093 and JP-A-2003-57820 may be added to the upper layer and/or the lower layer.

Examples of nonionic surfactants are sorbitan tristearate, sorbitan monopalmitate, sorbitan trioleate, stearic acid monoglyceride, polyoxyethylene nonyl phenyl ether and the like.

Examples of amphoteric surfactants include alkyl di (aminoethyl) glycine, alkylpolyaminoethylglycine hydrochloride, 2-alkyl-N-carboxyethyl-N-hydroxyethylimidazolinium betaine and N-tetradecyl-N,N-betaine type amphoteric surfactant (for example, trade name; AMOGEN K, manufactured by Daiichikogyo Seiyaku Co., Ltd.).

The amphoteric surfactant makes up a range of preferably from 0.01% by mass to 15% by mass, more preferably from 0.01% by mass to 5% by mass and still more preferably from 0.05% by mass to 2.0% by mass of the total solid content of the lower layer or the upper layer.

### (Printing-Out Agent/Colorant)

The upper layer and/or the lower layer may contain a dye or a pigment as a printing-out agent or an image colorant to immediately form a visible image after the heating caused by exposure.

Details of the printing-out agent and the colorant are described in paragraph Nos. [0122] to [0123] of JP-A-2009-229917. Accordingly, these compounds described therein may be also suitably used in the present invention.

These dyes are preferably added at a ratio of 0.01 to 10% by mass relative to the total solids content of the lower layer or the upper layer, and more preferably at a ratio of 0.1 to 3% by mass.

### (Plasticizer)

A plasticizer may be added to the upper layer and/or the lower layer in order to impart flexibility, etc. to the coating. Examples thereof include butylphthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, and oligomers and polymers of acrylic acid or methacrylic acid.

These plasticizers are preferably added at a ratio of 0.5 to 10% by mass relative to the total solids content of the lower layer or the upper layer, and more preferably at a ratio of 1.0 to 5% by mass.

### (Wax)

For the purpose of imparting resistance to scratching, a compound that reduces the coefficient of static friction of the surface may be added to the upper layer. Specific examples thereof include compounds comprising esters of long chain alkylcarboxylic acids, such as those described in U.S. Pat. No. 6,117,913, JP-A-2003-149799, JP-A-2003-302750, or JP-A-2004-12770.

The amount thereof added as a proportion in the upper layer is preferably 0.1 to 10% by mass, and more preferably 0.5 to 5% by mass.

### <Formation of Lower Layer and Upper Layer>

The lower layer and the upper layer of the planographic original printing plate of the present invention may usually be formed by dissolving the above-mentioned components in a solvent and coating an appropriate support therewith.

The solvent is not particularly limited, and may be selected from known solvents such as ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxy ethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, or toluene. These solvents may be used alone, or in combination of two or more thereof.

The lower layer and the upper layer are in principle preferably formed as two separate layers.

Examples of a method for forming two separate layers include a method in which a difference in solvent solubility between components contained in the lower layer and components contained in the upper layer is utilized and a method in which, after an upper layer is applied, the solvent is rapidly removed by drying. Separation between these layers is performed more favorably by combining these methods.

These methods are described in detail below, but the method for coating as two separate layers is not limited to these methods.

As the method in which a difference in solvent solubility between components contained in the lower layer and components contained in the upper layer is utilized, a solvent system in which all of the components contained in the lower layer are insoluble is used when applying an upper layer coating solution. This enables each layer to be formed in a clearly separated manner even when carrying out two-layer coating. For example, making two layers is possible by selecting as a lower layer component a component that is insoluble in a solvent, such as methyl ethyl ketone or 1-methoxy-2-propanol, that dissolves an alkali-soluble resin, which is an upper layer component, coating and drying the lower layer using a solvent system that dissolves the lower layer component, and subsequently dissolving an upper layer mainly containing an alkali-soluble resin in methyl ethyl ketone, 1-methoxy-2-propanol, etc., followed by coating and drying.

The method for very rapidly drying the solvent after a second layer (upper layer) is applied may be achieved by blowing high-pressure air via a slit nozzle placed at substantially right angles relative to the web travel direction, applying thermal energy as conductive heat from a lower face of a web using a roll having a heating medium such as steam supplied to the interior thereof (heating roll), or combining the above.

The dry coat weight of the lower layer component applied onto the support of the planographic original printing plate is preferably in the range of 0.5 to 4.0 g/m², and more preferably in the range of 0.6 to 2.5 g/m². When it is at least 0.5 g/m², printing durability is excellent, and when it is no greater than 4.0 g/m², image reproduction and sensitivity are excellent.

The dry coat weight of the upper layer component is preferably in the range of 0.05 to 1.0 g/m², and more preferably in the range of 0.08 to 0.7 g/m². When it is at least 0.05 g/m², the development latitude and scratch resistance are excellent, and when it is no greater than 1.0 g/m², the sensitivity is excellent.

The dry coat weight of the lower layer and the upper layer in total is preferably in the range of 0.6 to 4.0 g/m², and more preferably in the range of 0.7 to 2.5 g/m². When it is at least 0.6 g/m², the printing durability is excellent, and when it is no greater than 4.0 g/m², the image reproduction and the sensitivity are excellent.

### <Recording Layer in the Case of Single Layered Structure>

The recording layer of the planographic original printing plate of the present invention may have not alone the layered structure described above, but a single structure. The image recording layer in the case of the single structure contains at least (A) a star polymer, (B) an alkali-soluble resin, and (C) an infrared absorbing agent, and if needed, contains other components described above. Formation of the image recording layer may be performed by an arbitrary coating method using a solvent in the same manner as the formation of the upper layer and the lower layer of the layered structure.

The coating amount after drying in the case of the single structure is preferably a range of from 0.6 g/m² to 4.0 g/m², and more preferably from 0.7 g/m² to 2.5 g/m². If the coating amount is 0.6 g/m² or more, good plate durability may be achieved. Meanwhile, if the coating amount is 4.0 g/m² or less, good image reproduction and favorable sensitivity may be achieved.

### <Substrate>

A polyester film and an aluminum plate are preferable as a substrate in the present invention. Among them, an aluminum plate is particularly preferable because of its dimensional stability and low cost. Suitable aluminum plate is a pure aluminum plate and an alloy plate having aluminum as a main component and containing trace quantities of other elements. A plastic film laminated or deposited with aluminum may be used. Examples of the other elements contained in the aluminum alloy are silicon, iron, manganese, copper, magnesium, chromium, zinc, bismuth, nickel, titanium and the like. Content of the other elements in the alloy is at most 10% by mass.

Particularly suitable aluminum is pure aluminum. However, since it is difficult to manufacture completely pure aluminum in view of refining techniques, trace quantities of other elements may be contained.

As mentioned above, components of aluminum plate used in the present invention are not limited to specific ones. Aluminum plates which have been previously known and used can be arbitrarily used. The thickness of the aluminum plate used in the present invention is approximately 0.1 mm to 0.6 mm, preferably 0.15 mm to 0.4 mm, particularly preferably 0.2 mm to 0.3 mm.

The aluminum plate may be subjected to various kinds of surface treatments such as roughening or anodization. For the surface treatment of the aluminum plate, treatments may be carried out appropriately, such as a degreasing treatment with a surfactant, an organic solvent, an alkaline aqueous solution, or the like, a roughening treatment on the surface, or an anodic oxidation treatment, as described in detail in paragraph Nos. [0167] to [0169] of JP-A-2009-175195.

After the anodic oxidation treatment, the surface of the aluminum plate is subjected to, as necessary, a hydrophilizing treatment.

Examples of the hydrophilizing treatment to be used include an alkali metal silicate method (for example, sodium silicate aqueous solution) and a method of treating with potassium fluorinated zirconate or polyvinyl sulfonic acid, as described in paragraph No. [0169] of JP-A-2009-175195.

### <Undercoat Layer>

In the present invention, an undercoat layer may be provided between the support and the lower layer as needed.

As undercoat layer components, various organic compounds may be used, and it may be selected from preferable examples including a carboxymethylcellulose, an amino group-containing phosphonic acid, such as a dextrin, an organic phosphonic acid, an organic phosphoric acid, an organic phosphinic acid, an amino acid, and a hydroxy group-containing amine hydrochloride. With regard to these undercoat layer components, one type may be used on its own or two or more types may be used as a mixture. Examples of the undercoat layer components to be used and a method of forming the undercoat layer can be arbitrarily used, as described in paragraphs Nos. [0171] to [0172] of JP-A-2009-175195.

The coverage of the organic undercoat layer is preferably 2 to 200 mg,/m², and more preferably 5 to 100 mg/m². When the coverage is in the above-mentioned range, sufficient printing durability can be obtained.

### <Back Coat Layer>

In reverse side of the substrate, a back coat may be formed, if necessary. Preferred examples of the back coat are a coating layer obtained by an organic polymeric compound described in Japanese Patent Application Laid-Open (JP-A) No. 5-45,885 and a coating layer which comprises a metallic oxide and is obtained by hydrolyzing an organic or inorganic metallic compound and polycondensing the resulting product as described in Japanese Patent Application Laid-Open (JP-A) No. 6-35,174. Among these coating layers, layers made from alkoxy compounds of silicon such as Si(OCH₃)₄, Si(OC₂H₅)₄, Si(OC₃H₇)₄ and Si(OC₄H₉)₄ are particularly preferable, because these compounds are inexpensive and the coating layers of metal oxides made from these compounds are excellent in resistance to developing solution.

The planographic original printing plate prepared as described above is image-wise exposed, and then subjected to a development processing.

### <Method for Making a Planographic Printing Plate>

A method for making a planographic printing plate according to the invention includes: an exposure step of performing image-wise exposure to infrared of the above-described infrared-sensitive positive-type planographic original printing plate of the present invention; and a development step of developing the exposed planographic original printing plate using an alkaline aqueous solution with a pH of from 8.5 to 10.8 in this order.

According to the method for making a planographic printing plate according to the invention, the stability after printing is improved. As a result, the obtained planographic printing plate has a high strength of the image area and an excellent durability without generation of stain caused by a residual film in the non-image area.

Each step of the plate making is described in detail below.

### <Exposure Step>

The process for making a planographic printing plate of the present invention comprises an exposure step of imagewise exposing the positive-working planographic original printing plate for infrared laser.

The actinic radiation light source used for imagewise exposure of the planographic original printing plate is preferably a light source having an emission wavelength in the near-infrared to infrared region, and is more preferably a solid-state laser or a semiconductor laser. Among them, in the present invention, it is particularly preferable to carry out imagewise exposure using a solid-state laser or semiconductor laser that emits infrared radiation having a wavelength of 750 to 1,400 nm.

The laser output is preferably at least 100 mW, and in order to shorten the exposure time it is preferable to use a multi-beam laser device. It is also preferable for the exposure time per pixel to be within 20 μsec.

The energy with which a planographic original printing plate is irradiated is preferably 10 to 300 mJ/cm². When in this range, curing progresses sufficiently, laser ablation can be suppressed, and damage to an image can be prevented.

Exposure in the present invention may be carried out by making light beams of the light source overlap. Overlap means that the sub-scanning pitch width is smaller than the beam diameter. When the beam diameter is expressed as a full width half maximum (FWHM) of the beam intensity, the overlap may be expressed quantitatively using for example FWHM/sub-scanning pitch width (overlap factor). In the present invention, this overlap factor is preferably at least 0.1.

The scanning method of the light source of exposure equipment that can be used in the present invention is not particularly limited, and a cylinder outer face scanning method, a cylinder inner face scanning method, a flat face scanning method, etc. may be used. The light source channel may be single channel or multi channel, but in the case of the cylinder outer face method multi channel is preferably used.

### <Exposure Step>

### Developing Solution

The method for making a planographic printing plate according to the invention includes a development step of developing the planographic original printing plate using an alkaline aqueous solution. The alkaline aqueous solution (hereinafter, also referred to as “a developing solution”) used in the development step is preferably an alkaline aqueous solution having a pH of from 8.5 to 10.8, more preferably from 9.0 to 10.0. Further, the developing solution preferably contains a surfactant, and more preferably contains at least an anionic surfactant or a nonionic surfactant. The surfactant contributes to improvement in developability. Herein, the pH is defined as the value obtained by measurement at room temperature (25° C.) using F-51 (trade name) manufactured by HORIBA, Ltd.

As for the surfactant used in the developing solution, any one of anionic surfactants, nonionic surfactants, cationic surfactants, and amphoteric surfactants may be used. As already described above, anionic surfactants or nonionic surfactants are preferable.

The anionic surfactant for use in the developer is not particularly limited and includes, for example, fatty acid salts, abietic acid salts, hydroxyalkanesulfonic acid salts, alkanesulfonic acid salts, dialkylsulfosuccinic acid salts, straight-chain alkylbenzenesulfonic acid salts, branched alkylbenzenesulfonic acid salts, alkylnaphthalenesulfonic acid salts, alkyldiphenylether (di)sulfonic acid salts, alkylphenoxy polyoxyethylene propylsulfonic acid salts, polyoxyethylene alkylsulfophenyl ether salts, N-methyl-N-oleyltaurine sodium salt, N-alkylsulfosuccinic acid monoamide disodium salts, petroleum sulfonic acid salts, sulfated castor oil, sulfated beef tallow oil, sulfate ester slats of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styryl phenyl ether sulfate ester salts, alkyl phosphate ester salts, polyoxyethylene alkyl ether phosphate ester salts, polyoxyethylene alkyl phenyl ether phosphate ester salts, partially saponified products of styrene-maleic anhydride copolymer, partially saponified products of olefin-maleic anhydride copolymer and naphthalene sulfonate formalin condensates. Of the compounds, alkylbenzenesulfonic acid salts, alkylnaphthalenesulfonic acid salts and alkyldiphenylether (di)sulfonic acid salts are particularly preferably used.

The cationic surfactant used in the developing solution in the present invention is not particularly limited, and hitherto known cationic surfactants may be used. Examples of the cationic surfactants include alkyl amine salts, quaternary ammonium salts, polyoxyethylene alkyl amine salts, and polyethylene polyamine derivatives.

The nonionic surfactant for use in the developer is not particularly limited and includes, for example, polyethylene glycol type higher alcohol ethylene oxide adducts, alkylphenol ethylene oxide adducts, alkylnaphthol ethylene oxide adducts, phenol ethylene oxide adducts, naphthol ethylene oxide adducts, fatty acid ethylene oxide adducts, polyhydric alcohol fatty acid ester ethylene oxide adducts, higher alkylamine ethylene oxide adducts, fatty acid amide ethylene oxide adducts, ethylene oxide adducts of fat, polypropylene glycol ethylene oxide adducts, dimethylsiloxane-ethylene oxide block copolymers, dimethylsiloxane-(propylene oxide-ethylene oxide) block copolymers, fatty acid esters of polyhydric alcohol type glycerol, fatty acid esters of pentaerythritol, fatty acid esters of sorbitol and sorbitan, fatty acid esters of sucrose, alkyl ethers of polyhydric alcohols and fatty acid amides of alkanolamines. Of the compounds, those having an aromatic ring and an ethylene oxide chain are preferred, and alkyl-substituted or unsubstituted phenol ethylene oxide adducts or, alkyl-substituted or unsubstituted naphthol ethylene oxide adducts are more preferred.

The amphoteric surfactant used in the developing solution in the present invention is not particularly limited. Examples of the amphoteric surfactants include: amine oxides such as alkyldimethylamine oxides; betaines such as alkyl betaines; and amino acids such as sodium salts of alkylamino fatty acid. In particular, an alkyldimethylamine oxide which may have a substituent, an alkyl carboxy betaine which may have a substituent and an alkyl sulfo betaine which may have a substituent are preferably used. Specific examples of these compounds include those described in, for example, paragraph Nos. [0255] to [0278] of JP-A-2008-203359 and paragraph Nos. [0028] to [0052] of JP-A-2008-276166, which may be used in the present invention.

Further, from the viewpoints of stable solubility and suspensibility with respect to water, the HLB value is preferably 6 or more, and more preferably 8 or more. Although the upper limit of HLB value is not particularly limited, it is usually 20 or less.

As for the surfactant used in the developing solution, anionic surfactants and nonionic surfactants are preferable. Anionic surfactants containing sulfonic acid or a salt thereof and nonionic surfactants containing an aromatic ring and an ethylene oxide chain are especially preferable.

Two or more kinds of the surfactant may be used in combination.

The content of the surfactant in the developer is preferably from 0.01 to 10 mass %, and more preferably from 0.01 to 5 mass %.

In order to maintain the pH of the developer within a favorable range, a carbonate ion and a bicarbonate ion are preferably present as buffers in the developer. This is likely due to that the carbonate and bicarbonate ions control the variation of the pH during long-time use of the developer, and thus prevent the deterioration of developability and the generation of development wastes caused by pH variation. In order to establish the presence of the carbonate and bicarbonate ions in the developer, a carbonate and a bicarbonate (or hydrogen carbonate) may be added to the developer, or the pH may be adjusted after the addition of a carbonate or hydrogen carbonate, to generate carbonate and bicarbonate ions. The carbonate and the hydrogen carbonate are not particularly limited, but are preferably alkali metal salts. Examples of the alkali metal include lithium, sodium, and potassium. Among them, sodium is particularly preferred. They may be used alone, or in combination of two or more thereof.

The total amount of carbonate and bicarbonate is preferably from 0.3 to 20% by mass, more preferably from 0.5 to 10% by mass, and particularly preferably from 1 to 5% by mass, with respect to the mass of the developing solution. When the total amount is 0.3% by mass or more, the developability and processing ability are not deteriorate, and when the total amount is 20% by mass or less, precipitates or crystals are hardly formed, and gelation hardly occurs during neutralization for the treatment of the waste developer, so that the treatment is carried out smoothly.

Further, in order to supplement a delicate adjustment of the alkali concentration and dissolution of a photosensitive layer of the non-image area, other alkali agent such as an organic alkali agent may be supplementarily used together. Examples of organic alkali agent include monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, prydine, and tetramethylanmoniumhydroxide. These alkali agents can be used singly or in the combination thereof.

The developing solution may each contain, in addition to the above-described components, other components such as a surfactant other than those described above, an organic alkali agent, a humectant, an antiseptic, a chelate compound, an anti-foaming agent, an organic acid, an organic solvent, a polar solvent, an inorganic acid, or an inorganic salt. Note that since addition of a water-soluble polymeric compound to a developing solution facilitates to make a surface of the printing plate sticky especially in the time when the developing solution has fatigued, no addition of the water-soluble polymeric compound is preferable.

As a humectant, ethylene glycol, propylene glycol, triethylene glycol buthylene glycol, hexylene glycol, diethylene glycol, dipropylene glycol glycerin, trymethylol propane, diglycerin are favorably used. These humectants can be used singly or in the combination thereof. The content of the humectant to be used is 0.1 to 5 mass % is preferable, relative to the entire mass of developer.

Examples of the antiseptic useful include phenols and derivatives thereof, formalin, imidazole derivatives, sodium dehydroacetate, 4-isothiazolin-3-one derivatives, benzoisothiazolin-3-one, 2-methyl-4-isothiazolin-3-one, benzotriazole derivatives, amidine guanidine derivatives, derivatives of quaternary ammonium salts, pyridine, quinoline, and guanidine, derivatives of diazine and triazole, derivatives of oxazole and oxazine, and nitro bromo alcohols such as 2-bromo-2-nitropropane-1,3-diol, and 1,1-dibromo-1-nitro-2-ethanol, and 1,1-dibromo-1-nitro-2-propanol. In order to exhibit efficacy against various molds and bacteria, it is preferred that two or more antiseptics be used in combination. The amount of the antiseptic must be enough for exhibiting stable efficacy against bacteria, molds, and yeasts, and the preferred amount is, though it depends on the type of the bacteria, molds, and yeasts, from 0.01 to 4% by mass with respect to the process liquid.

Examples of the chelate compound include ethylenediamine tetraacetic acid, potassium salts thereof, and sodium salts thereof; diethylenetriamine pentaacetic acid, potassium salts thereof, and sodium salts thereof; triethylenetetramine hexaacetic acid, potassium salts thereof, and sodium salts thereof; hydroxyethyl ethylenediamine triacetic acid, potassium salts thereof, and sodium salts thereof; nitrilotriacetic acid, and sodium salts thereof; 1-hydroxyethane-1,1-diphosphonic acid, potassium salts thereof, and sodium salts thereof; and organic phosphonic acids and phosphonoalkane tricarboxylic acids such as aminotri(methylenephosphonic acid), potassium salts thereof, and sodium salts thereof. Organic amine salts may be used in place of the sodium or potassium salts of the chelating agent. The chelating agent is preferably selected from those stably exists in the process liquid, and do not impair the printability. The amount of the chelating agent is preferably from 0.001 to 1.0% by mass with respect to the process liquid.

Examples of the anti-foaming agent include common silicon-containing compounds of self emulsification type, emulsification type, or nonionic type, having an HLB of 5 or less. Among them, silicon anti-foaming agents are preferred, which may be of emulsion-dispersion or soluble type. The content of the anti-foaming agent is preferably from 0.001 to 1.0% by mass with respect to the process liquid.

Examples of the organic acid useful include citric acid, acetic acid, oxalic acid, malonic acid, salicylic acid, caprylic acid, tartaric acid, malic acid, lactic acid, levulinic acid, p-toluenesulfonic acid, xylene sulfonic acid, phytic acid, and organic phosphonic acid. The organic acid may be in the form of an alkali metal salt or an ammonium salt. The content of the organic acid is preferably from 0.01 to 0.5% by mass with respect to the process liquid.

Examples of the organic solvent useful include aliphatic hydrocarbons (for example, hexane, heptane, and ISOPAR E, H, and G (trade names, manufactured by Esso Chemical Ltd.), gasoline, and kerosene), aromatic hydrocarbons (for example, toluene and xylene), hydrocarbon halides (for example, methylene dichloride, ethylene dichloride, trichlene, and monochlorobenzene), and polar solvents.

Examples of the polar solvent include alcohols (for example, methanol, ethanol, isopropanol, ethylene glycol monophenyl ether and 2-ethoxyethanol), ketones (for example, acetone, methyl ethyl ketone, and cyclohexanone), esters (for example, ethyl acetate, and propylene glycol monomethyl ether acetate), and other polar solvents (for example, triethyl phosphate, tricresyl phosphate, N-phenylethanolamine, and N-phenyldiethanolamine).

When the organic solvent is insoluble in water, it may be solubilized to water using, for example, a surfactant. When the developer contains an organic solvent, the solvent concentration is preferably less than 40% by mass from the viewpoints of safety and flammability.

Examples of the inorganic acid and inorganic salt include phosphoric acid, metaphosphoric acid, ammonium dihydrogen phosphate, diammonium hydrogen phosphate, sodium dihydrogen phosphate, sodium hydrogen phosphate, potasium dihydrogen phosphate, potasium hydrogen phosphate, sodium tripolyphosphate, potassium pyrophosphate, sodium hexametaphosphate magnesium nitrate, sodium nitrate, potassium nitrate, ammonium nitrate, sodium sulfate, potassium sulfate, ammonium sulfate, sodium sulfite, ammonium sulfite, sodium hydrogen sulfate, and nickel sulfate. The content of the inorganic salt is preferably from 0.01 to 0.5% by mass with respect to the total mass of the process liquid.

### (Development Treatment)

The development temperature is not particularly limited as long as development is possible, but is preferably no greater than 60° C., and more preferably 15° C. to 40° C. In development processing using an automatic processor, since the developer might be exhausted depending on the amount processed, the processing performance may be recovered by use of a replenisher or fresh developer. As one example of development and post-development treatments, there is a method in which alkali development is carried out, the alkali is removed by a water washing post-step, a gumming treatment is carried out in a gumming step, and drying is carried out in a drying step. As another example, a method in which a water washing pre-step, a development step, and a gumming step are carried out at the same time using an aqueous solution containing carbonate ions, bicarbonate ions, and a surfactant can be cited as a preferred example. It is therefore preferable to carry out a drying step after carrying out a water washing pre-step, a development step, and a gumming step by the use of one solution and, furthermore, with one bath, without particularly carrying out a water washing pre-step. It is preferable to carry out drying subsequent to removal of extra developer using a squeegee roller, etc. after development.

It is more preferred that the development step be carried out using an automatic processor equipped with a rubbing member. Examples of the automatic processor include automatic processors as disclosed in JP-A-2-220061 and JP-A-60-59351, in which a planographic original printing plate after image-wise exposure is subjected to rubbing treatment while being transferred, and automatic processors as disclosed in U.S. Pat. No. 5,148,746, U.S. Pat. No. 5,568,768, and U.K. Patent No. 2297719, in which a planographic original printing plate after image-wise exposure is mounted on a cylinder, and subjected to rubbing treatment while the cylinder is rotated. Among them, an automatic processor having a rotary brush roll as a rubbing member is particularly preferred.

The rotating brush roller which can be preferably used in the invention can be appropriately selected by taking account, for example, of scratch resistance of the image area and nerve strength of the support of the planographic original printing plate. As for the rotating brush roller, a known rotating brush roller produced by implanting a brush material in a plastic or metal roller can be used. For example, a rotating brush roller described in JP-A-58-159533 and JP-A-3-100554, or a brush roller described in JP-U-B-62-167253 (the term “JP-UM-B” as used herein means an “examined Japanese utility model publication”), in which a metal or plastic groove-type member having implanted therein in rows a brush material is closely radially wound around a plastic or metal roller acting as a core, can be used.

As the brush material, a plastic fiber (for example, a polyester-based synthetic fiber, e.g., polyethylene terephthalate or polybutylene terephthalate; a polyamide-based synthetic fiber, e.g., nylon 6.6 or nylon 6.10; a polyacrylic synthetic fiber, e.g., polyacrylonitrile or polyalkyl(meth)acrylate; and a polyolefin-based synthetic fiber, e.g., polypropylene or polystyrene) can be used. For instance, a brush material having a fiber bristle diameter of 20 to 400 .mu.m and a bristle length of 5 to 30 mm can be preferably used.

The outer diameter of the rotating brush roller is preferably from 30 to 200 mm, and the peripheral velocity at the tip of the brush rubbing the plate surface is preferably from 0.1 to 5 m/sec. Further, it is preferred to use a plurality, that is, two or more of the rotating brush rollers.

The rotary direction of the rotating brush roller for use in the invention may be the same direction or the opposite direction with respect to the transporting direction of the planographic original printing plate of the invention, but when two or more rotating brush rollers are used in an automatic processor as shown in the Drawing, it is preferred that at least one rotating brush roller rotates in the same direction and at least one rotating brush roller rotates in the opposite direction with respect to the transporting direction. By such arrangement, the photosensitive layer in the non-image area can be more steadily removed. Further, a technique of rocking the rotating brush roller in the rotation axis direction of the brush roller is also effective.

It is preferred that a continuous or discontinuous drying step be performed after the development step. The drying is carried out using, for example, hot air, infrared radiation, or far infrared rays.

As for the automatic processor favorably used in the method for making the planographic printing plate according to the present invention, an apparatus equipped with a development unit and drying unit is used. The planographic original printing plate was subjected to development and gumming treatment in a developer tank, and then dried in the drying unit to obtain a planographic printing plate.

For the purpose of increasing the image strength and printing durability, the heating after the development can be performed using a very strong condition. Ordinarily, the heat treatment is carried out in a temperature range of 200 to 500° C. When the temperature is too low, a sufficient effect of strengthening the image may not be obtained, whereas when it is excessively high, problems of deterioration of the support and thermal decomposition of the image area may occur.

The planographic printing plate thus obtained is loaded into an offset printing press, and is favorably used for a large number of prints.

The thermal positive-type planographic original printing plate of the present invention exhibits an excellent chemical resistance including retention of the unexposed area against a processing, a good developability of the exposed area, and a good durability (plate durability), and realizes a high development latitude. Further, the thermal positive-type planographic original printing plate exhibits high performances in the above-described terms and suppresses reduction in developability due to aging after exposure whereby a good stability after printing can be realized, even in the case where development is performed with a low pH developing solution.

Further, the production method of the present invention makes it possible to make favorably a planographic printing plate that exhibits high printing performances described above.

### EXAMPLES

The present invention will be described in more detail based on examples given below, but the invention is not meant to be limited by these.

### Synthesis Example

### Synthesis of Star-Shaped Polymer (P-1)

13.22 g of N, N-dimethyl acetoamide and 3.46 g of MA-1 were weighed and placed in a three-necked flask, and then heated at 80° C. under a nitrogen stream. To this solution, a mixed solution composed of 13.84 g of MA-1, 6.41 g of MB-1, 3.18 g of MB-14, 1.43 g of CT-1, 0.46 g of V-601 (trade name, manufactured by Wako Pure Chemical Industries, Ltd.) and 52.86 g of N, N-dimethyl acetoamide was added dropwise over 2 and a half hours. After termination of dropwise addition, a reaction was allowed to continue additionally for 3 hours. After reaction, the resultant reaction liquid was poured into 4000 g of well-agitated water thereby precipitating a solid. The precipitated solid was collected by filtration and dried under reduced pressure to obtain the star polymer (P-1) represented by the above-described structural formula. The mass-average molecular weight of the obtained polymer was 55,000.

### Example 1, Comparative Example 1

### Original Printing Plate having a Single-Layered Recording Layer

### <Preparation of Support>

The surface of a JIS A 1050 aluminum sheet was subjected to graining by means of a rotating nylon brush using a pumice-water suspension as an abrasive. Here, the surface roughness (center line average roughness) was 0.5 μm. After washing with water, the sheet was immersed in a 10% sodium hydroxide aqueous solution, that had been heated to 70° C., and subjected to etching so that the amount of aluminum dissolved was 6 g/m³. After washing with water, the sheet was immersed in a 30% nitric acid aqueous solution for 1 min., so as to carry out neutralization, and washed well with water. Subsequently, it was subjected to electrolytic roughening for 20 sec. in a 0.7% nitric acid aqueous solution using a rectangular alternating waveform voltage with a voltage of 13 V for the anode and a voltage of 6 V for the cathode, immersed in a 20% sulfuric acid solution at 50° C., so as to wash the surface, and then washed with water.

The roughened aluminum sheet was subjected to formation of a porous anodized coating using direct current in a 20% sulfuric acid aqueous solution. Electrolysis was carried out at an electric current density of 5 A/dm², and a substrate having on the surface an anodized coating with a weight of 4.0 g/m² was formed by controlling the electrolysis time. This substrate was treated for 10 sec in a vapor chamber that had been saturated at 100° C. and 1 atm, thus giving a substrate (a) with a sealing ratio of 60%.

The substrate (a) was subjected to a surface hydrophilization treatment using a 2.5% by mass aqueous solution of sodium silicate at 30° C. for 10 sec and then coated with undercoat solution 1 described below, and the coating was dried at 80° C. for 15 sec., thus giving a planographic printing plate support [A]. The dried coating coverage was 15 mg/m².

(Undercoat Solution 1)

| | |
|---|---|
| Copolymer below having a | 0.3 g |
| molecular weight of 28,000 | |
| Methanol | 100 g |
| Water | 1 g |

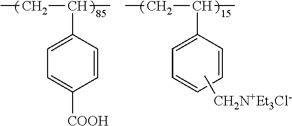

Molecular weight: 28,000

### <Formation of Recording Layer>

On the undercoated support [A] thus obtained, the following photosensitive liquid 1 was coated so as to provide 1.8 g/m² of a coating amount, and dried to form a photosensitive layer (recording layer). Thus, the planographic original printing plate having a single-layered structure as shown in FIG. 2 was obtained.

(Photosensitive liquid 1)

| | |
|---|---|
| Novolak resin | 1.0 g |
| (m-cresol/p- cresol (6/4), mass average molecular weight | |
| 7,000, unreacted cresol 0.5 mass %) | |
| Star polymer in which the main chain has three or more | 1.0 g |
| branches (Shown in the following Table 2) | |
| Cyanine dye A (having the following structure) | 0.1 g |
| Phthalic anhydride | 0.05 g |
| P-toluenesulfonic acid | 0.002 g |
| Dye in which the counterion of Ethyl Violet was | 0.02 g |
| 6-hydroxy-β-naphthalenesulfonic acid ion | |
| Fluorine-based surfactant (trade name: | 0.015 g |
| Megafac F-176 (solid content 20%), | |
| manufactured by DIC Corporation) | |
| Fluorine-based surfactant (trade name: | 0.035 g |
| Megafac MCF-312 (solid content 30%), | |
| manufactured by DIC Corporation) | |
| Methyl ethyl ketone | 4.0 g |
| Propylene glycol monomethyl ether | 4.0 g |
| (manufactured by Nippon Nyukazai Co., Ltd.) | |
| γ-Butyrolactone | 4.0 g |

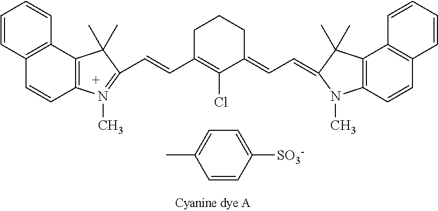

### <Evaluation of Retention Time of Unexposed Area>

The obtained planographic original printing plate was immersed changing a residence time in a developer tank in which a dilution of the developing solution DT-2 (trade name, manufactured by FUJIFILM Corporation) (the solution diluted so as to exhibit conductivity of 43 mS/cm) was placed. The immersion time at which the image density reached 95% of the image density to be obtained by the developing solution-unimmersed original printing plate was defined as a retention time of the unexposed area.

### <Developing Time of Exposed Area>

A test pattern was written imagewise on the planographic original printing plate using a Trendsetter (trade name) manufactured by Creo while changing the exposure energy. After that, this planographic original printing plate was immersed changing a residence time in a developer tank in which a dilution of the developing solution DT-2 (trade name, manufactured by FUJIFILM Corporation) (the solution diluted so as to exhibit conductivity of 43 mS/cm) was placed. The immersion time at which the image density reached the same as the image density of the Al support was defined as a developing time of the exposed area.

### <Evaluation of Development Latitude>

A test pattern was written imagewise on the planographic original printing plate using Trendsetter (trade name) manufactured by Creo at a beam intensity of 9 W and a drum rotational speed of 150 rpm. Subsequently, it was developed at a liquid temperature of 30° C. for a development time of 22 sec using a 900H PS processor (trade name) manufactured by Fujifilm charged with alkali developer having the composition below for which the electrical conductivity had been varied by changing the dilution ratio by changing the amount of water. In this process, the difference between the highest electrical conductivity and the lowest electrical conductivity of the developer that enabled good development to be carried out without the image area being dissolved and without causing stains or coloration due to residual photosensitive layer as a result of incomplete development was evaluated as the development latitude.

The results are given in Table 2.

### <Evaluation of Printing Durability>

A test patter was drawn imagewise on the planographic original printing plate under the conditions of beam intensity of 9 w and drum rotation speed of 150 rpm using TRENDSETTER (trade name) manufactured by Creo Products Inc. Subsequently, it was developed using an LP940H PS processor manufactured by Fujifilm charged with DT-2 (trade name) developer (diluted so as to have an electrical conductivity of 43 mS/cm) manufactured by Fujifilm at a development temperature of 30° C. for a development time of 12 sec. This was used for continuous printing using a Lithron printer (trade name) manufactured by Komori Corporation. The number of sheets that could be printed with sufficient ink density was visually measured, and the printing durability was evaluated. The printing durability was expressed as a relative value when the number for the printing durability of Comparative Example 1-1 was defined as 1.0. As the test pattern, a solid image (an overall image area) of 2 cm×2 cm was used. The number of print at the time when generation of graze and blank (or empty) was found by visual evaluation of the printed matter was defined as the print-ending number. At this time, “1.0” corresponded to 40,000 prints.

<Evaluation of Printing Durability after Baking>

The plate face of a planographic printing plate obtained in the same manner as in the above-mentioned printing durability evaluation was washed with water, then wiped with BC-7 (trade name) plate baking conditioner manufactured by Fujifilm, and then subjected to baking at about 270° C. for 2 min. Subsequently, washing with water was carried out, and the plate face was treated with a liquid prepared by diluting FP-2W (trade name) gum manufactured by Fujifilm with water to double the volume. Subsequently, in the same manner as for the printing durability evaluation, printing was carried out by means of a Lithron printer manufactured by Komori Corporation using DIC-GEOS(N) (trade name) black ink manufactured by DIC Corporation, and printing durability after baking was evaluated by the number of prints at the point where the density of a solid image could be visually recognized to have become weak. The printing durability was expressed as a relative value with the number for the printing durability of Comparative Example 1-1 defined as 1.0.

### <Evaluation of Chemical Resistance>

The planographic original printing plate was subjected to exposure, development, and printing in the same manner as in the above-mentioned printing durability evaluation. A step in which the plate face was wiped with a cleaner (Multicleaner, Fujifilm) each time after 5,000 sheets were printed was added, and the chemical resistance was evaluated. When this printing durability was at least 95% but no greater than 100% of the above-mentioned number of sheets for printing durability it was evaluated as Excellent (AA), at least 80% but less than 95% as Good (A), at least 60% but less than 80% as Fair (B), and less than 60% as Poor (C). When the step of wiping the plate face using a cleaner was added, the smaller the change in the number of sheets for printing durability, the better the chemical resistance. The results are given in Table 2 below.

<Developing Time of Exposed Area after Exposure Aging>

A test pattern was written imagewise on the planographic original printing plate using a Trendsetter manufactured by Creo while changing the exposure energy. Then, after completion of still standing of the planographic original printing plate under the conditions of room temperature of 25° C. and humidity of 60% for 40 minutes, the planographic original printing plate was immersed changing a residence time in a developer tank in which a dilution of the developing solution DT-2 (trade name, manufactured by FUJIFILM Corporation) (the solution diluted so as to exhibit conductivity of 43 mS/cm) was placed. The immersion time at which the image density reached the same as the image density of the Al support was defined as a developing time of the exposed area.

(Developer)

| | |
|---|---|
| D-Sorbit | 2.5 mass % |
| Sodium hydroxide | 0.85 mass % |
| Polyethylene glycol lauryl ether | 0.5 mass % |
| (weight average molecular weight: 1,000) | |
| Water | 96.15 mass % |

TABLE 2

| | | Retention | Developing | | | | | Developing |
|---|---|---|---|---|---|---|---|---|
| | | time of | time of | | | | | time of exposed |
| | Star- | unexposed | exposed | Development | | Printing | | area after |
| | shaped | area | area | Latitude | Printing | Durability after | Chemical | exposure aging |
| | polymer | (sec) | (sec) | (mS/cm) | Durability | Baking | resistance | (sec) |
| Example 1-1 | P-1 | 20 | 10 | 8 | 1.0 | 1.5 | AA | 10 |
| Example 1-2 | P-2 | 20 | 10 | 8 | 1.0 | 1.5 | AA | 10 |
| Example 1-3 | P-3 | 21 | 10 | 8 | 1.0 | 1.5 | AA | 10 |
| Example 1-4 | P-6 | 20 | 8 | 9 | 1.0 | 1.5 | AA | 8 |
| Example 1-5 | P-8 | 21 | 6 | 10 | 1.0 | 1.5 | AA | 6 |
| Example 1-6 | P-9 | 23 | 7 | 10 | 1.0 | 1.5 | AA | 7 |
| Example 1-7 | P-10 | 20 | 5 | 10 | 1.0 | 1.5 | AA | 5 |
| Example 1-8 | P-11 | 18 | 10 | 7 | 1.1 | 1.6 | A | 10 |
| Example 1-9 | P-12 | 17 | 9 | 7 | 0.9 | 1.3 | A | 9 |
| Example 1-10 | P-13 | 18 | 10 | 7 | 1.0 | 1.4 | A | 10 |
| Example 1-11 | P-14 | 22 | 11 | 8 | 1.1 | 1.5 | A | 11 |
| Example 1-12 | P-16 | 23 | 8 | 10 | 1.0 | 1.5 | AA | 8 |
| Example 1-13 | P-20 | 20 | 10 | 8 | 1.0 | 1.5 | A | 10 |
| Example 1-14 | P-21 | 21 | 8 | 8 | 1.0 | 1.5 | A | 8 |
| Example 1-15 | P-22 | 18 | 8 | 8 | 0.9 | 1.4 | A | 8 |
| Example 1-16 | P-23 | 20 | 10 | 8 | 1.0 | 1.4 | A | 10 |
| Example 1-17 | P-31 | 23 | 7 | 8 | 1.1 | 1.6 | A | 7 |
| Example 1-18 | P-32 | 23 | 7 | 10 | 1.2 | 1.7 | AA | 7 |
| Example 1-19 | P-33 | 23 | 7 | 10 | 1.2 | 1.7 | AA | 7 |
| Example 1-20 | P-34 | 26 | 8 | 11 | 1.2 | 1.7 | AA | 8 |
| Comparative | REF-1 | 22 | 13 | 5 | 1.0 | 1.3 | A | 17 |
| Example 1-1 | | | | | | | | |
| Comparative | REF-2 | 22 | 13 | 5 | 1.0 | 1.3 | A | 17 |
| Example 1-2 | | | | | | | | |
| Comparative | REF-3 | 26 | 14 | 5 | 1.2 | 1.5 | A | 17 |
| Example 1-3 | | | | | | | | |

| | Thiol | Hydrophilic | Hydrophilic | Other | Other | Molecular weight | Function |
|---|---|---|---|---|---|---|---|
| Number | compound | monomer I | monomer II | monomer I | monomer II | (Ten thousand) | number |
| REF-1 | Nothing | MA-1 | | MB-1 | MB-14 | 5.5 | 0 |
| | 0 | 36 | | 31 | 32 | | |
| REF-2 | CT-REF | MA-1 | | MB-1 | MB-14 | 5.5 | 2 |
| | 3 | 36 | | 31 | 30 | | |
| REF-3 | CT-REF | MA-2 | MA-7 | MB-13 | | 5.0 | 2 |
| | 3 | 25 | 24 | 48 | | | |

Note)
In Table, values in lower shelf represent mol %.

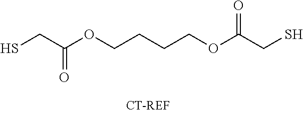

As is apparent from the results shown in Table 2, it is seen that developability, development latitude and chemical resistance are improved by use of the star polymer in which a main chain has three or more branches according to Examples, when compared to the polymers in which a main chain has two branches and the polymer in which a main chain has no branch, all of which are used in Comparative Examples. Further, it was confirmed that deterioration of the developability due to aging after exposure in Examples was less than that in the Comparative Examples.

Meanwhile, the use of the star polymer in which a main chain has three or more branches according to Examples has additional advantage from the viewpoint of plate durability after a burning treatment. This advantage was an unexpected effect.

### Example 2, Comparative Example 2

### Original Printing Plate having a Multi-Layered Recording Layer

### <Preparation of Support>

The surface of a JIS A 1050 aluminum sheet having a thickness of 0.3 mm was subjected to graining by means of a rotating nylon brush using a pumice-water suspension as an abrasive. Here, the surface roughness (center line average roughness) was 0.5 μm. After washing with water, the sheet was immersed in a 10% sodium hydroxide aqueous solution, that had been heated to 70° C., and subjected to etching so that the amount of aluminum dissolved was 6 g/m³. After washing with water, the sheet was immersed in a 30% nitric acid aqueous solution for 1 min., so as to carry out neutralization, and washed well with water. Subsequently, it was subjected to electrolytic roughening for 20 sec. in a 0.7% nitric acid aqueous solution using a rectangular alternating waveform voltage with a voltage of 13 V for the anode and a voltage of 6 V for the cathode, immersed in a 20% sulfuric acid solution at 50° C., so as to wash the surface, and then washed with water. The roughened aluminum sheet was subjected to formation of a porous anodized coating using direct current in a 20% sulfuric acid aqueous solution. Electrolysis was carried out at an electric current density of 5 A/dm², and a substrate having on the surface an anodized coating with a mass of 4.0 g/m² was formed by controlling the electrolysis time. This substrate was treated for 10 sec in a vapor chamber that had been saturated at 100° C. and 1 atm, thus giving a substrate (b) with a sealing ratio of 60%. The substrate (b) was subjected to a surface hydrophilization treatment using a 2.5% by mass aqueous solution of sodium silicate at 30° C. for 10 sec and then coated with undercoat solution 1 described below, and the coating was dried at 80° C. for 15 sec., thus giving a planographic printing plate support [B]. The dried coating coverage was 15 mg/m².

### <Undercoat Intermediate Layer>

The following undercoat solution for forming an undercoat layer was coated on the support [B] produced as described above, and then dried at 80° C. for 15 seconds to provide an interlayer. The covering amount after drying was 15 mg/m².

(Undercoat Solution 1)

| | |
|---|---|
| Copolymer below having a | 0.5 g |
| molecular weight of 28,000 | |
| Methanol | 100 g |
| Water | 1 g |

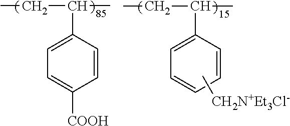

Molecular weight: 28,000

### <Formation of Recording Layer>

The undercoated support [B] thus obtained was provided with a lower layer by coating it with the photosensitive liquid I having the composition below using a wire bar and drying in a drying oven at 150° C. for 40 sec., so as to give a coat weight of 1.3 g/m². After the lower layer was provided, an upper layer was provided by coating with the undercoat solution II having the composition below using a wire bar. After coating, drying was carried out at 150° C. for 40 sec, thus giving a planographic original printing plate for infrared laser having a total coat weight for the lower layer and the upper layer of 1.7 g/m². Thus, the planographic original printing plate having a multi-layered structure as shown in FIG. 1 was obtained.

| (Photosensitive liquid I) | | |
|---|---|---|
| Star-shaped polymer described in Table 3 | 3.5 | g |
| Dye in which the counteranion of Ethyl Violet was | 0.15 | g |
| 6-hydroxy-β-naphthalenesulfonic acid ion | | |
| Infrared absorbing agent (The above-described cyanine dye A) | 0.25 | g |
| Bisphenol sulfone | 0.3 | g |
| Tetrahydro-phthalic acid | 0.4 | g |
| Fluorine-based surfactant (trade name: Megafac F-780, | 0.02 | g |
| manufactured by DIC Corporation) | | |
| Methyl ethyl ketone | 30 | g |
| Propylene glycol monomethyl ether | 15 | g |
| γ-Butyrolactone | 15 | g |
| (Photosensitive liquid II) | | |
| Novolak resin (m-cresol/p-cresol/phenol = 3/2/5, Mw8,000) | 0.68 | g |
| Infrared absorbing agent (The above-described cyanine dye A) | 0.045 | g |
| Fluorine-based surfactant (trade name: Megafac F-780, | 0.03 | g |
| manufactured by DIC Corporation) | | |
| Methyl ethyl ketone | 15.0 | g |
| 1-Methoxy-2-propanol | 30.0 | g |

Print evaluations of the obtained original printing plate were conducted in the same manner as Example 1.

TABLE 3

| | | Retention | Developing | | | | | Developing time |
|---|---|---|---|---|---|---|---|---|
| | Star- | time of | time of | Development | | Printing | | of exposed area |
| | shaped | unexposed | exposed | Latitude | Printing | Durability | Chemical | after exposure |
| | polymer | area (sec) | area (sec) | (mS/cm) | Durability | after Baking | resistance | aging (sec) |
| Example 2-1 | P-1 | 25 | 11 | 10 | 1.0 | 1.5 | AA | 11 |
| Example 2-2 | P-2 | 25 | 11 | 10 | 1.0 | 1.5 | AA | 11 |
| Example 2-3 | P-3 | 26 | 11 | 10 | 1.0 | 1.5 | AA | 11 |
| Example 2-4 | P-6 | 25 | 9 | 11 | 1.0 | 1.5 | AA | 9 |
| Example 2-5 | P-8 | 26 | 7 | 12 | 1.0 | 1.5 | AA | 7 |
| Example 2-6 | P-9 | 28 | 8 | 12 | 1.0 | 1.5 | AA | 8 |
| Example 2-7 | P-10 | 25 | 6 | 12 | 1.0 | 1.5 | AA | 6 |
| Example 2-8 | P-11 | 23 | 11 | 9 | 1.1 | 1.6 | A | 11 |
| Example 2-9 | P-12 | 22 | 10 | 9 | 0.9 | 1.3 | A | 10 |
| Example 2-10 | P-13 | 23 | 11 | 9 | 1.0 | 1.4 | A | 11 |
| Example 2-11 | P-16 | 28 | 9 | 12 | 1.0 | 1.5 | AA | 9 |
| Example 2-12 | P-31 | 28 | 8 | 10 | 1.1 | 1.6 | A | 8 |
| Example 2-13 | P-32 | 28 | 8 | 12 | 1.2 | 1.7 | AA | 8 |
| Example 2-14 | P-33 | 28 | 8 | 12 | 1.2 | 1.7 | AA | 8 |
| Example 2-15 | P-34 | 31 | 9 | 13 | 1.2 | 1.7 | AA | 9 |
| Comparative | REF-1 | 27 | 14 | 7 | 1.0 | 1.3 | A | 17 |
| Example 2-1 | | | | | | | | |
| Comparative | REF-2 | 27 | 14 | 7 | 1.0 | 1.3 | A | 15 |
| Example 2-2 | | | | | | | | |
| Comparative | REF-3 | 31 | 15 | 7 | 1.2 | 1.5 | A | 17 |
| Example 2-3 | | | | | | | | |

As is apparent from the results shown in Table 3, it is seen that excellent effects can be also obtained in the planographic original printing plate having a multilayered structure by use of the star polymer in which a main chain has three or more branches according to Examples.

### Example 3, Comparative Example 3

### Original Printing Plate having a Multi-Layered Recording Layer

A support was prepared in the same manner as the example 2.

### <Undercoat Intermediate Layer>

An undercoat intermediate layer was prepared in the same manner as the example 2, except that the undercoat solution 1 for forming an undercoat layer was changed to the following undercoat solution 2 for forming an undercoat layer.

(Undercoat Solution 2)

| | |
|---|---|
| Copolymer below having a | 0.3 g |
| molecular weight of 31,000 | |
| Methanol | 100 g |
| Water | 1 g |

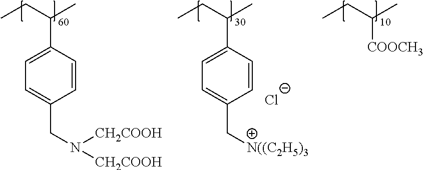

Molecular weight: 31,000

### <Formation of Recording Layer>

The undercoated support [B] thus obtained was provided with a lower layer by coating it with the photosensitive liquid III having the composition below using a wire bar and drying in a drying oven at 150° C. for 40 sec., so as to give a coat weight of 1.3 g/m². After the lower layer was provided, an upper layer was provided by coating with the photosensitive liquid IV having the composition below using a wire bar. After coating, drying was carried out at 150° C. for 40 sec, thus giving a photosensitive planographic original printing plate for infrared laser having a total coat weight for the lower layer and the upper layer of 1.7 g/m². Thus, the planographic original printing plate having a multi-layered structure as shown in FIG. 1 was obtained.

| (Photosensitive liquid III) | | |
|---|---|---|
| Binder polymer (REF-1) | 3.5 | g |
| Dye in which the counteranion of Ethyl Violet was | 0.15 | g |
| 6-hydroxy-β-naphthalenesulfonic acid ion | | |
| m,p-Cresol novolac resin (m/p ratio = 6/4, | 0.6 | g |
| mass average weight: 6,000) | | |
| Infrared absorbing agent (The above-described cyanine dye A) | 0.25 | g |
| Bisphenol sulfone | 0.3 | g |
| Tetrahydro-phthalic acid | 0.4 | g |
| Fluorine-based surfactant (trade name: Megafac F-780, | 0.02 | g |
| manufactured by DIC Corporation) | | |
| Methyl ethyl ketone | 30 | g |
| Propylene glycol monomethyl ether | 15 | g |
| γ-Butyrolactone | 15 | g |
| (Photosensitive liquid IV) | | |
| Novolak resin (m-cresol/p-cresol/phenol 3/2/5, Mw8,000) | 0.68 | g |
| Star-shaped polymer described in Table 4 | 0.20 | g |
| Infrared absorbing agent (The above-described cyanine dye A) | 0.045 | g |
| Fluorine-based surfactant (trade name: Megafac F-780, | 0.03 | g |
| manufactured by DIC Corporation) | | |
| Methyl ethyl ketone | 15.0 | g |
| 1-Methoxy-2-propanol | 30.0 | g |

The result of evaluations conducted in the same manner as the example 1 was shown in Table 4.

TABLE 4

| | | Retention | Developing | | | | | Developing time |
|---|---|---|---|---|---|---|---|---|
| | Star- | time of | time of | Development | | Printing | | of exposed area |
| | shaped | unexposed | exposed | Latitude | Printing | Durability | Chemical | after exposure |
| | polymer | area (sec) | area (sec) | (mS/cm) | Durability | after Baking | resistance | aging (sec) |
| Example 3-1 | P-1 | 26 | 11 | 10 | 1.0 | 1.5 | AA | 11 |
| Example 3-2 | P-4 | 26 | 11 | 10 | 1.0 | 1.5 | AA | 11 |
| Example 3-3 | P-5 | 26 | 9 | 11 | 1.0 | 1.5 | AA | 9 |
| Example 3-4 | P-7 | 26 | 9 | 11 | 1.0 | 1.5 | AA | 9 |
| Example 3-5 | P-8 | 27 | 7 | 12 | 1.0 | 1.5 | AA | 7 |
| Example 3-6 | P-9 | 29 | 8 | 12 | 1.0 | 1.5 | AA | 8 |
| Example 3-7 | P-10 | 26 | 6 | 12 | 1.0 | 1.5 | AA | 6 |
| Example 3-8 | P-11 | 24 | 10 | 7 | 1.1 | 1.6 | A | 10 |
| Example 3-9 | P-12 | 23 | 9 | 7 | 0.9 | 1.4 | A | 9 |
| Example 3-10 | P-15 | 22 | 9 | 7 | 0.9 | 1.4 | A | 9 |
| Example 3-11 | P-17 | 25 | 8 | 9 | 0.9 | 1.4 | AA | 8 |
| Example 3-12 | P-18 | 25 | 8 | 9 | 0.9 | 1.4 | AA | 8 |
| Example 3-13 | P-19 | 25 | 8 | 9 | 0.9 | 1.4 | AA | 8 |
| Example 3-14 | P-22 | 24 | 8 | 9 | 1.0 | 1.5 | AA | 8 |
| Example 3-15 | P-23 | 26 | 8 | 9 | 1.0 | 1.5 | AA | 8 |
| Example 3-16 | P-24 | 26 | 8 | 9 | 1.0 | 1.5 | AA | 8 |
| Example 3-17 | P-25 | 26 | 9 | 8 | 1.0 | 1.5 | A | 9 |
| Example 3-18 | P-26 | 26 | 9 | 8 | 1.0 | 1.5 | A | 9 |
| Example 3-19 | P-27 | 26 | 9 | 8 | 1.0 | 1.5 | A | 9 |
| Example 3-20 | P-28 | 26 | 9 | 8 | 1.0 | 1.5 | A | 9 |
| Example 3-21 | P-29 | 24 | 9 | 7 | 1.0 | 1.5 | A | 9 |
| Example 3-22 | P-30 | 24 | 9 | 7 | 1.0 | 1.5 | A | 9 |
| Example 3-23 | P-31 | 24 | 8 | 10 | 1.0 | 1.5 | A | 8 |
| Example 3-24 | P-32 | 30 | 8 | 12 | 1.2 | 1.7 | AA | 8 |
| Example 3-25 | P-33 | 30 | 8 | 12 | 1.2 | 1.7 | AA | 8 |
| Example 3-26 | P-34 | 30 | 8 | 12 | 1.2 | 1.7 | AA | 8 |
| Comparative | REF-1 | 27 | 14 | 6 | 1.0 | 1.3 | A | 17 |
| Example 3-1 | | | | | | | | |
| Comparative | REF-2 | 27 | 14 | 6 | 1.0 | 1.3 | A | 15 |
| Example 3-2 | | | | | | | | |
| Comparative | REF-3 | 31 | 15 | 6 | 1.2 | 1.5 | A | 17 |
| Example 3-3 | | | | | | | | |

As is apparent from the results shown in Table 4, it is seen that excellent effects can be also obtained in another embodiment of the planographic original printing plate having a multilayered structure by use of the star polymer in which a main chain has three or more branches according to Examples.

### Example 4, Comparative Example 4

### Original Printing Plate having a Multi-Layered Recording Layer

### <Preparation of Support><Formation of Undercoating Intermediate Layer>

A support and an undercoating intermediate layer were prepared in the same manner as the example 1.

### <Formation of Recording Layer>

The undercoated support thus obtained was provided with a lower layer by coating it with the photosensitive liquid V having the composition below using a wire bar and drying in a drying oven at 150° C. for 40 sec., so as to give a coat weight of 1.2 g/m². After the lower layer was provided, an upper layer was provided by coating with the photosensitive liquid VI having the composition below using a wire bar. After coating, drying was carried out at 150° C. for 40 sec, thus giving a photosensitive planographic original printing plate for infrared laser having a total coat weight for the lower layer and the upper layer of 1.6 g/m². Thus, the planographic original printing plate having a multi-layered structure as shown in FIG. 1 was obtained.

(Photosensitive liquid V)

| | |
|---|---|
| Star-shaped polymer described in Table 5 | 3.5 g |
| Dye in which the counteranion of Ethyl Violet was | 0.15 g |
| 6-hydroxy-β-naphthalenesulfonic acid ion | |
| m,p-Cresol novolac resin | 0.6 g |
| (m/p ratio = 6/4, mass average weight: 6,000) | |
| Infrared absorbing agent (The above-described cyanine dye A) | 0.25 g |
| Bisphenol sulfone | 0.3 g |
| Tetrahydro-phthalic acid | 0.4 g |
| Fluorine-based surfactant (trade name: Megafac F-780, | 0.02 g |
| manufactured by DIC Corporation) | |
| Methyl ethyl ketone | 30 g |
| Propylene glycol monomethyl ether | 15 g |
| γ-Butyrolactone | 15 g |
| (Photosensitive liquid VI) | |
| Novolak resin (m-cresol/p-cresol/phenol 3/2/5, Mw 8,000) | 0.68 g |
| The polyurethane described below | 0.15 g |
| Infrared absorbing agent (The above-described cyanine dye A) | 0.045 g |
| Fluorine-based surfactant (trade name: Megafac F-780, | |
| manufactured by DIC Corporation) | 0.03 g |
| Methyl ethyl ketone | 15.0 g |
| 1-Methoxy-2-propanol | 30.0 g |

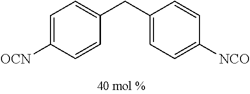

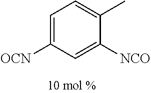

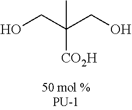

Mw = 28000

### <Evaluation of Retention Time of Unexposed Area>

Evaluation of retention time of the unexposed area was conducted in the same manner as the example 1, except that the following developing liquid 2 was used as a developing liquid.

### <Evaluation of Development Time of Exposed Area>

Evaluation of development of exposed area was conducted in the same manner as the example 1, except that the following developing liquid 2 was used as a developing liquid.

### <Evaluation of Development Latitude>

Evaluation of development latitude was conducted in the same manner as the example 1, except that the following developing liquid 2 was used as a developing liquid and development was conducted by the following development step.

### <Evaluation of Plate Durability>

Evaluation of plate durability was conducted in the same manner as the example 1, except that the following developing liquid 2 was used as a developing liquid and development was conducted by the following development step.

<Evaluation of Plate Durability after Burning Treatment>

Evaluation of plate durability after burning treatment was conducted in the same manner as the example 1, except that the following developing liquid 2 was used as a developing liquid and development was conducted by the following development step.

### <Evaluation of Chemical Resistance>

Evaluation of chemical resistance was conducted in the same manner as the example 1, except that the following developing liquid 2 was used as a developing liquid and development was conducted by the following development step.

<Developing Time of Exposed Area after Exposure and Subsequent Forced Aging>

Evaluation of development of exposed area was conducted in the same manner as the example 1, except that the following developing liquid 2 was used as a developing liquid.

### (Development Step)

The exposed planographic original printing plate was developed at 30° C. using the developer below by means of the automatic processor (development tank 25 L, plate transport speed 100 cm/min, one brush roller having an outer diameter of 50 mm and having implanted therein fibers of polybutylene terephthalate (bristle diameter: 200 μm, bristle length: 17 mm) and being rotated at 200 rpm in the same direction as the transport direction (peripheral speed at brush tip: 0.52 m/sec), drying temperature 80 C°).

(Developer 2)

| | | |
|---|---|---|
| Water | 8963.8 | g |
| Sodium carbonate | 200 | g |
| Sodium hydrogencarbonate | 100 | g |
| Newcol B4SN (trade name, polyoxyethylene naphthyl ether | 300 | g |
| sulfate, manufactured by Nippon Nyukazai Co., Ltd.) | | |
| EDTA 4Na | 80 | g |
| 2-Bromo-2-nitropropanediol | 0.1 | g |
| 2-Methyl-4-isothiazolin-3-one (pH = 9.7) | 0.1 | g |

Results are shown in Table 5.

TABLE 5

| | | Retention | Developing | | | | | Developing time |
|---|---|---|---|---|---|---|---|---|
| | Star- | time of | time of | Development | | Printing | | of exposed area |
| | shaped | unexposed | exposed | Latitude | Printing | Durability | Chemical | after exposure |
| | polymer | area (sec) | area (sec) | (mS/cm) | Durability | after Baking | resistance | aging (sec) |
| Example 4-1 | P-1 | 26 | 12 | 9 | 1.1 | 1.6 | AA | 12 |
| Example 4-2 | P-2 | 26 | 12 | 9 | 1.0 | 1.5 | AA | 12 |
| Example 4-3 | P-3 | 27 | 12 | 9 | 1.0 | 1.5 | AA | 12 |
| Example 4-4 | P-6 | 26 | 10 | 10 | 1.0 | 1.5 | AA | 10 |
| Example 4-5 | P-8 | 27 | 8 | 11 | 1.1 | 1.6 | AA | 8 |
| Example 4-6 | P-9 | 29 | 9 | 11 | 1.1 | 1.6 | AA | 9 |
| Example 4-7 | P-10 | 26 | 7 | 11 | 1.0 | 1.5 | AA | 7 |
| Example 4-8 | P-11 | 24 | 12 | 8 | 1.1 | 1.6 | A | 12 |
| Example 4-9 | P-12 | 23 | 11 | 8 | 0.9 | 1.3 | A | 11 |
| Example 4-10 | P-13 | 24 | 12 | 8 | 1.0 | 1.4 | A | 12 |
| Example 4-11 | P-16 | 29 | 10 | 11 | 1.0 | 1.5 | AA | 10 |
| Example 4-12 | P-31 | 29 | 9 | 9 | 1.1 | 1.6 | A | 9 |
| Example 4-13 | P-32 | 29 | 9 | 11 | 1.2 | 1.7 | AA | 9 |
| Example 4-14 | P-33 | 29 | 9 | 11 | 1.2 | 1.7 | AA | 9 |
| Example 4-15 | P-34 | 32 | 10 | 12 | 1.2 | 1.7 | AA | 10 |
| Comparative | REF-1 | 28 | 15 | 6 | 1.0 | 1.3 | A | 17 |
| example 4-1 | | | | | | | | |
| Comparative | REF-2 | 28 | 15 | 6 | 1.0 | 1.3 | A | 15 |
| example 4-2 | | | | | | | | |
| Comparative | REF-3 | 32 | 16 | 6 | 1.2 | 1.5 | A | 17 |
| example 4-3 | | | | | | | | |

As is apparent from the results shown in Table 5, it is seen that excellent effects can be also obtained in yet another embodiment of the planographic original printing plate having a multilayered structure by use of the star polymer in which a main chain has three or more branches according to Examples.

### REFERENCE SIGNS LIST

1: Image recording layer
3: Undercoat layer
4: Support
11: Upper layer of recording layer
12: Lower layer of recording layer
10, 20: Planographic printing plate

Having described our invention as related to the present embodiments, it is our intention that the invention not be limited by any of the details of the description, unless otherwise specified, but rather be construed broadly within its spirit and scope as set out in the accompanying claims.

This application claims priority on Patent Application No. 2011-053869 filed in Japan on Mar. 11, 2011, which is entirely herein incorporated by reference.

What we claim is:

1. A thermal positive-type planographic original printing plate comprising a support and at least one recording layer provided on the support, either the same layer or different layers of the recording layer comprising: a star polymer in which at least three polymer chains bind to a core comprised of atomic groups and are radially branching; and an infrared absorbing agent.

2. The thermal positive-type planographic original printing plate according to claim 1, wherein the star polymer is at least one of compounds represented by formulae (I) to (VIII): 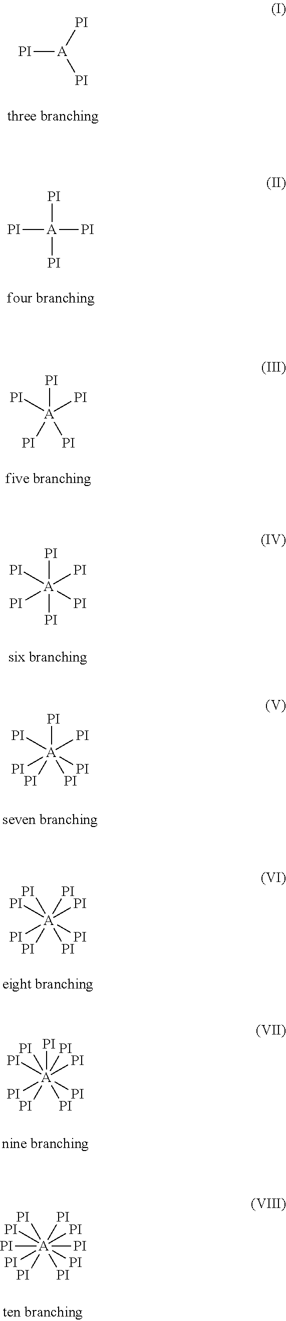
wherein P1 represents a polymer chain having a molecular weight of 1,000 to 1,000,000; and A represents a group of atoms having a molecular weight of 100 to 1,500.

3. The thermal positive-type planographic original printing plate according to claim 2, wherein A in the above-described formulae (I) to (VIII) is a compound derived from a sulfur-containing chain transfer agent.

4. The thermal positive-type planographic original printing plate according to claim 1, wherein a raw material compound that forms the core of the above-described star polymer is represented by any one of the following formula (CT-1) to Formula (CT-9):

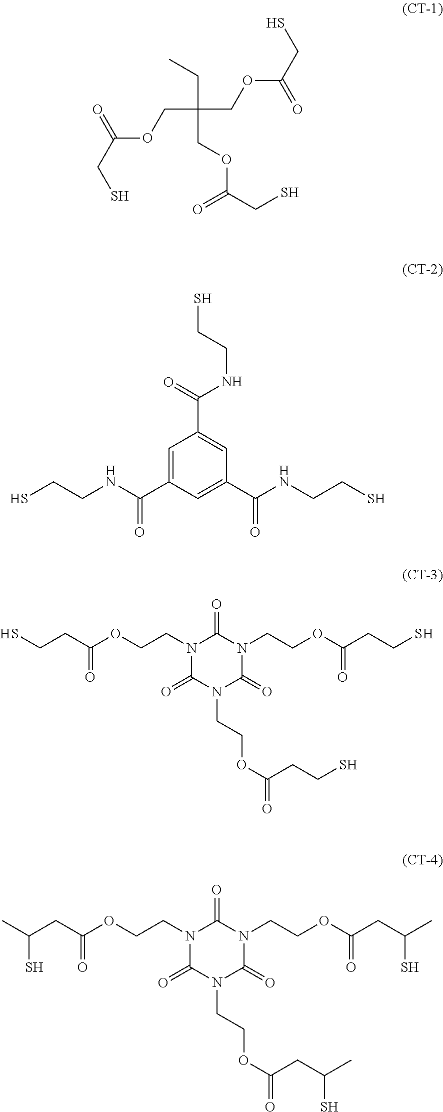

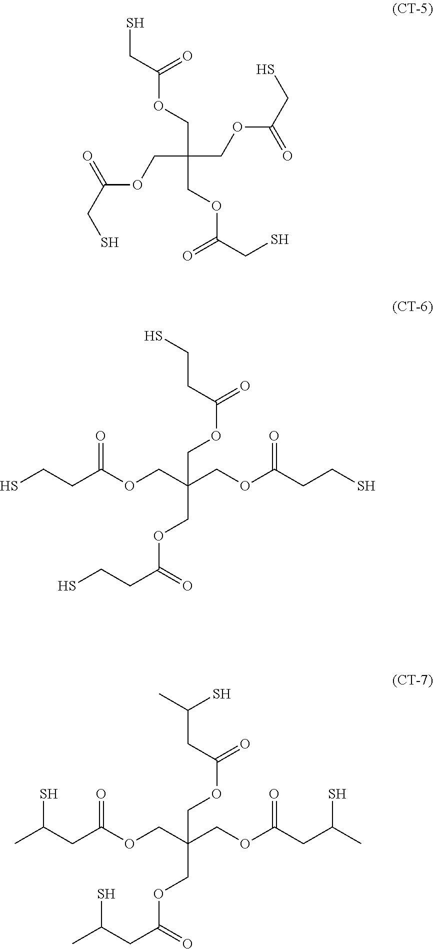

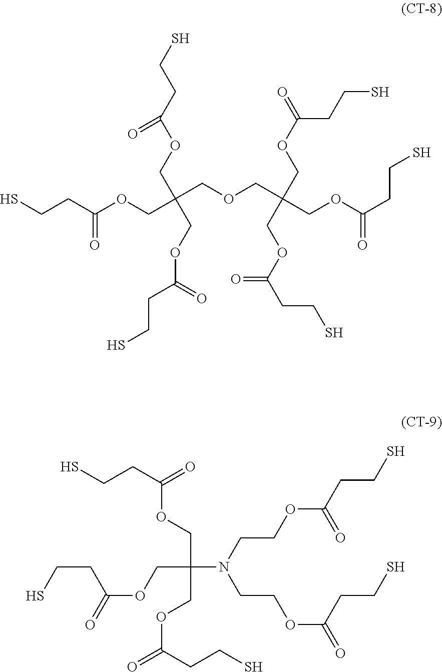

5. The thermal positive-type planographic original printing plate according to claim 2, wherein the polymer side chain P1 of the above-described formulae (I) to (VIII) is derived from the compound selected from the group consisting of the compounds represented by the following formulae (A) to (C): 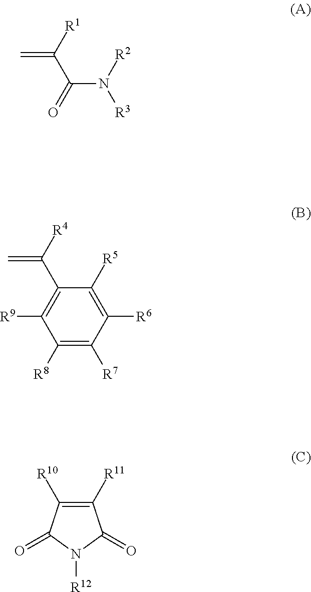
wherein R¹ and R⁴ each independently represents a hydrogen atom or a methyl group; R², R³, R⁵ to R¹² each independently represents a hydrogen atom or a monovalent organic group; and R² and R³, and R¹⁰ and R¹¹ may bind to each other to form a ring.

6. The thermal positive-type planographic original printing plate according to claim 1, wherein the above-described recording layer further comprises an alkali-soluble resin.

7. The thermal positive-type planographic original printing plate according to claim 1, wherein the thermal positive-type planographic original printing plate comprises, in the following order as layers on the above-described support, an undercoat layer, and a lower layer and an upper layer each of which serves as the recording layer.

8. The thermal positive-type planographic original printing plate according to claim 7, wherein the upper layer or the lower layer of the recording layer comprises the above-described star polymer, and the upper layer further comprises a novolac resin that serves as the above-described alkali-soluble resin.

9. The thermal positive-type planographic original printing plate according to claim 7, wherein the above-described lower layer further comprises the above described infrared absorbing agent.

10. A method of making a planographic printing plate, comprising, in the following order:
subjecting the recording layer of the planographic original printing plate according to claim 1 to image-wise exposure; and
developing the planographic original printing plate using an alkaline aqueous solution which has a pH of from 8.5 to 10.8.

11. The method of making a planographic printing plate according to claim 10, wherein the alkaline aqueous solution comprises an anionic surfactant or a nonionic surfactant.
